(19) United States
(12) Patent Application Publication
(10) Pub. No.: US 2024/0278436 A1
(43) Pub. Date: Aug. 22, 2024

(54) CONTROL DEVICE, CONTROL METHOD, AND PROGRAM

(71) Applicant: Sony Group Corporation, Tokyo (JP)

(72) Inventor: Yoshikazu FURUYAMA, Tokyo (JP)

(73) Assignee: Sony Group Corporation, Tokyo (JP)

(21) Appl. No.: 18/570,668

(22) PCT Filed: Feb. 9, 2022
(86) PCT No.: PCT/JP2022/005154

§ 371 Date: Dec. 15, 2023

(30) Foreign Application Priority Data
Jun. 22, 2021 (JP) 2021-102969

(51) Int. Cl. B25J 13/08; G01S 5/30; G01S 15/08

(52) U.S. Cl. CPC B25J 13/084; G01S 5/30; G01S 15/08

(57) ABSTRACT

The present technology relates to a control device, a control method, and a program which enable easy detection of contact of an object with a predetermined surface in a case where the object is gripped and arranged on the predetermined surface.

In a case where a target object gripped by a finger portion including an ultrasonic transmitting element that generates an ultrasonic wave and a finger portion including an ultrasonic receiving element that receives the ultrasonic wave output from the ultrasonic transmitting element is to be arranged on an arrangement surface, a detection unit 104 detects contact of the target object with the arrangement surface on the basis of a sound pressure of the ultrasonic wave received by the ultrasonic receiving element. The present technology can be applied to, for example, a control device for a robot and the like.

### TECHNICAL FIELD

The present technology relates to a control device, a control method, and a program, and more particularly, to a control device, a control method, and a program which enable easy detection of contact of an object with a predetermined surface in a case where the object is gripped and arranged on the predetermined surface.

### BACKGROUND ART

In conventional robot systems, when an object is gripped by a robot hand and the gripped object is arranged on a predetermined surface, a reaction force received from the surface on which the object is to be placed is calculated so as not to give an impact to the object, and the object is released from the robot hand when the reaction force exceeds a threshold (see, for example, Patent Document 1).

Furthermore, there is also a robot system that acquires three-dimensional shape information of a conveyance target from three-dimensional information of a mountain before and after gripping and three-dimensional information of the conveyance target in order to suitably perform arrangement even in a case where a three-dimensional size of the conveyance target is unknown when one object is gripped as the conveyance target by a gripping device from the mountain of a plurality of stacked objects and is arranged on a predetermined surface (see, for example, Patent Document 2).

### CITATION LIST

### Patent Document

Patent Document 1: Japanese Patent Application Laid-Open No. 2007-276112
Patent Document 2: Japanese Patent Application Laid-Open No. 2016-144841

### SUMMARY OF THE INVENTION

### Problems to be Solved by the Invention

However, the robot systems described above need to perform complicated processing such as the calculation of the reaction force and the acquisition of the three-dimensional shape information in order to grip an object and suitably arrange the object on a predetermined surface.

Therefore, it is desired to easily detect contact of an object with a predetermined surface and suitably and easily arrange the object in a case where the object is gripped and arranged on the predetermined surface.

The present technology has been made in view of such a situation, and enables easy detection of contact of an object with a predetermined surface in a case where the object is gripped and arranged on the predetermined surface.

### Solutions to Problems

A control device according to one aspect of the present technology is a control device including a detection unit that detects contact of an object with a predetermined surface, in a case where the object, gripped by a first finger portion including an ultrasonic transmitter that generates an ultrasonic wave and a second finger portion including an ultrasonic receiver that receives the ultrasonic wave output from the ultrasonic transmitter, is to be arranged on the predetermined surface, on the basis of a sound pressure of the ultrasonic wave received by the ultrasonic receiver.

A control method according to one aspect of the present technology is a control method including detecting, by a control device, contact of an object with a predetermined surface, in a case where the object, gripped by a first finger portion including an ultrasonic transmitter that generates an ultrasonic wave and a second finger portion including an ultrasonic receiver that receives the ultrasonic wave output from the ultrasonic transmitter, is to be arranged on the predetermined surface, on the basis of a sound pressure of the ultrasonic wave received by the ultrasonic receiver.

A program according to one aspect of the present technology is a program for causing a computer to function as a detection unit that detects contact of an object with a predetermined surface, in a case where the object, gripped by a first finger portion including an ultrasonic transmitter that generates an ultrasonic wave and a second finger portion including an ultrasonic receiver that receives the ultrasonic wave output from the ultrasonic transmitter, is to be arranged on the predetermined surface, on the basis of a sound pressure of the ultrasonic wave received by the ultrasonic receiver.

In one aspect of the present technology, in a case where an object, gripped by a first finger portion including an ultrasonic transmitter that generates an ultrasonic wave and a second finger portion including an ultrasonic receiver that receives the ultrasonic wave output from the ultrasonic transmitter, is to be arranged on the predetermined surface, contact of the object with the predetermined surface is detected on the basis of a sound pressure of the ultrasonic wave received by the ultrasonic receiver.

### BRIEF DESCRIPTION OF DRAWINGS

FIG. 1 is a view illustrating an external configuration example in a first embodiment of a robot including a control device to which the present technology is applied.

FIG. 2 is a plan view illustrating a detailed configuration example of a finger portion in FIG. 1.

FIG. 3 is a block diagram illustrating a first configuration example of hardware of the robot in FIG. 1.

FIG. 4 is a block diagram illustrating a functional configuration example of an arrangement processing unit of a CPU in FIG. 3.

FIG. 5 is a view illustrating an outline of an arrangement process performed by the arrangement processing unit in FIG. 4.

FIG. 6 is a view illustrating a detection method in a detection unit of FIG. 4.

FIG. 7 is a view illustrating experimental results related to the arrangement process.

FIG. 8 is a view illustrating experimental results related to the arrangement process.

FIG. 9 is a view illustrating experimental results related to the arrangement process.

FIG. 10 is a view illustrating experimental results related to the arrangement process.

FIG. 11 is a flowchart illustrating a flow of the arrangement process performed by the arrangement processing unit in FIG. 4.

FIG. 12 is a flowchart illustrating an example of the arrangement process performed without using the present technology.

FIG. 13 is a block diagram illustrating a second configuration example of hardware of the robot in FIG. 1.

FIG. 14 is a block diagram illustrating a functional configuration example of an arrangement processing unit of a CPU in FIG. 13.

FIG. 15 is a view illustrating an outline of an arrangement process performed by the arrangement processing unit in FIG. 14.

FIG. 16 is a flowchart illustrating the arrangement process performed by the arrangement processing unit in FIG. 14.

FIG. 17 is a view illustrating a detailed configuration example of a finger portion in a second embodiment of a robot.

FIG. 18 is a block diagram illustrating a configuration example of hardware in the second embodiment of the robot.

FIG. 19 is a block diagram illustrating a functional configuration example of an arrangement processing unit of a CPU in FIG. 18.

FIG. 20 is a view illustrating a detailed configuration example of a finger portion in a third embodiment of a robot.

FIG. 21 is a block diagram illustrating a configuration example of hardware in the third embodiment of the robot.

FIG. 22 is a block diagram illustrating a functional configuration example of an arrangement processing unit of a CPU in FIG. 21.

### MODE FOR CARRYING OUT THE INVENTION

Hereinafter, modes for carrying out the present technology (hereinafter, referred to as embodiments) will be described. Note that the description will be given in the following order.
1. First Embodiment (Robot Including One Ultrasonic Transmitting Element and One Ultrasonic Receiving Element)
2. Second Embodiment (Robot Including Plurality of Ultrasonic Transmitting Elements)
3. Third Embodiment (Robot Including Plurality of Ultrasonic Receiving Elements)

Note that the same or similar portions are denoted by the same or similar reference signs in the drawings referred to in the following description. However, the drawings are schematic, and the relationship between the thickness and the plane dimension or the like is different from the actual one. Furthermore, the drawings also include portions having mutually different dimensional relationships and ratios in some cases.

### First Embodiment

### <External Configuration Example of Robot>

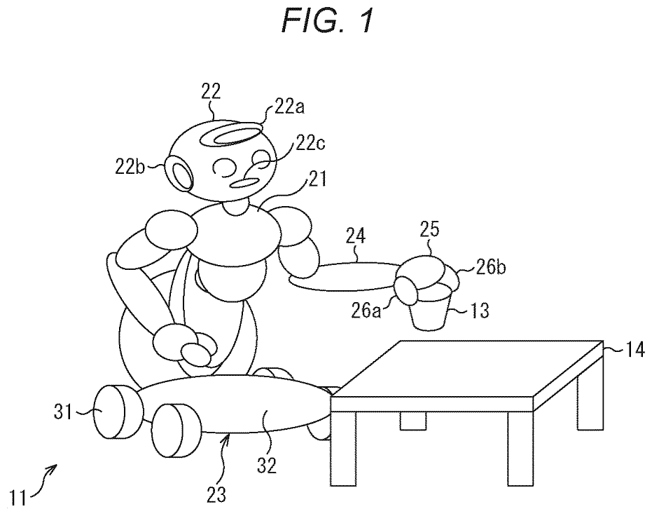

FIG. 1 is a diagram illustrating an external configuration example in a first embodiment of a robot including a control device to which the present technology is applied.

A robot 11 in FIG. 1 is a humanoid robot. Specifically, the robot 11 has a body portion 21, and a head portion 22, a leg portion 23, and arm portions 24 are connected to the top, bottom, and left and right of the body portion 21, respectively. A hand portion 25 is connected to a distal end of each of the arm portions 24, and the hand portion 25 has finger portions 26a and 26b.

An eye portion 22a including a camera is provided in the upper portion of the head portion 22. Ear portions 22b including microphones are provided on the left and right of the head portion 22, respectively. A mouth portion 22c including a speaker is provided in a lower portion of the head portion 22.

The leg portion 23 is provided with a tray portion 32 for placing a target object, which is an object to be transported, in addition to four wheels 31 for enabling the robot 11 to move. The robot 11 places a target object on the tray portion 32, moves to a transport destination, grips the target object with the finger portions 26a and 26b, arranges the target object on a predetermined surface (hereinafter, referred to as an arrangement surface), and releases the target object.

In the example of FIG. 1, the target object is a cup 13, the transport destination is a table 14, and the arrangement surface is an upper surface of the table 14. Therefore, the robot 11 first places the cup 13 on the tray portion 32 and moves to the table 14. Next, the robot 11 grips the cup 13 with the finger portions 26a and 26b, arranges and releases the cup 13 onto the upper surface of the table 14.

### <Detailed Configuration Example of Finger Portion>

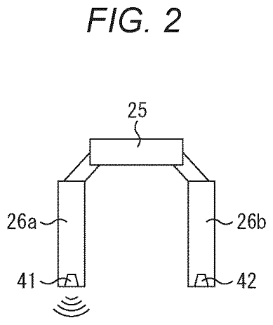

FIG. 2 is a plan view illustrating a detailed configuration example of the finger portions 26a and 26b in FIG. 1.

As illustrated in FIG. 2, the finger portion 26a and the finger portion 26b are connected, as grippers, to the left and right of the hand portion 25, respectively. An ultrasonic transducer is provided as an ultrasonic transmitting element 41 (am ultrasonic transmitter) at a distal end of the finger portion 26a (a first finger portion), and an ultrasonic receiving element 42 (an ultrasonic receiver) is provided at a distal end of the finger portion 26b. The ultrasonic transmitting element 41 generates an ultrasonic wave and outputs the ultrasonic wave in a predetermined orientation, and the ultrasonic receiving element 42 receives the ultrasonic wave output from the ultrasonic transmitting element 41.

### <First Configuration Example of Hardware of Robot>

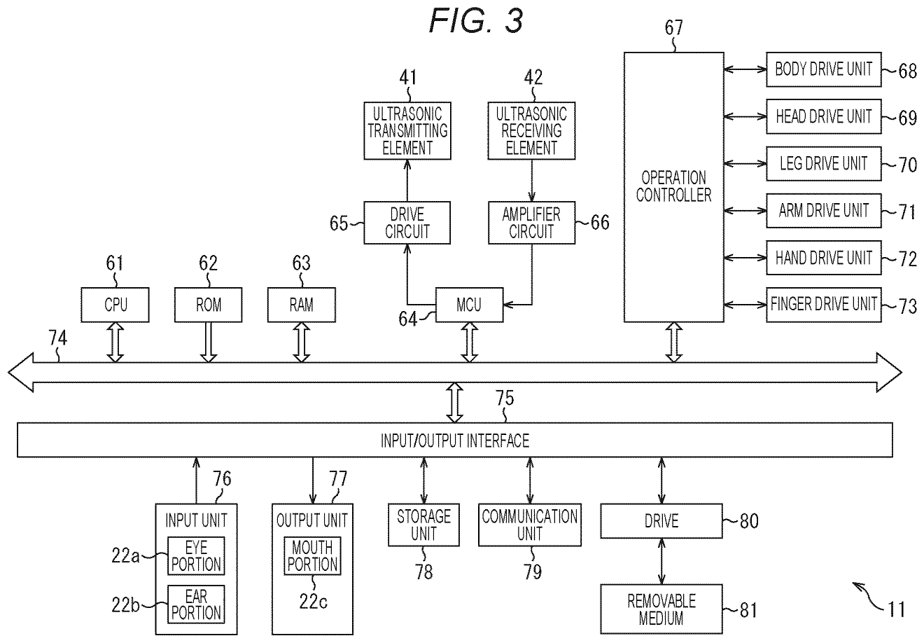

FIG. 3 is a block diagram illustrating a first configuration example of hardware of the robot 11 in FIG. 1.

In the robot 11, a central processing unit (CPU) 61, a read only memory (ROM) 62, and a random access memory (RAM) 63 are mutually connected by a bus 74. Furthermore, a microcontroller unit (MCU) 64 and an operation controller 67 are connected to the bus 74.

The CPU 61 is a control device that controls the entire robot 11, controls each portion, and performs various processes.

For example, the CPU 61 performs an arrangement process that is a process of holding the target object with the finger portion 26a and the finger portion 26b and arranging and releasing the target object onto the arrangement surface. Specifically, the CPU 61 instructs the MCU 64 to perform ultrasonic sensing. The CPU 61 acquires received wave information, which is information regarding the ultrasonic wave received by the ultrasonic receiving element 42, supplied from the MCU 64 in response to such an instruction. On the basis of the received wave information, the CPU 61 estimates a protrusion distance, which is a distance that protrudes from a gripping position of the target object to the arrangement surface side, and detects contact of the target object with the arrangement surface. The CPU 61 instructs the operation controller 67 to cause the robot 11 to perform a predetermined operation on the basis of an image acquired by the eye portion 22a, the protrusion distance, a detection result of the contact of the target object, and the like.

The MCU 64 is connected to a drive circuit 65 and an amplifier circuit 66, and performs ultrasonic sensing in response to an instruction from the CPU 61. Specifically, the MCU 64 drives the ultrasonic transmitting element 41 by supplying a rectangular pulse oscillating at a resonance frequency of the ultrasonic transmitting element 41 to the drive circuit 65 in response to an instruction from the CPU 61. The MCU 64 incorporates an analog/digital converter (AD converter), and samples a voltage corresponding to a sound pressure of the ultrasonic wave amplified by the amplifier circuit 66 by the AD converter. The MCU 64 performs signal processing on a digital signal obtained as a result of the sampling to calculate a reception time, a maximum voltage, and the like of the ultrasonic wave. Note that the reception time of the ultrasonic wave is a time from when the ultrasonic wave is output by the ultrasonic transmitting element 41 to a first peak of the ultrasonic waveform which is a waveform of the digital signal of the ultrasonic wave. The maximum voltage is a maximum value of the voltage in an ultrasonic waveform in a predetermined period. The MCU 64 supplies the CPU 61 with the reception time and the maximum voltage of the ultrasonic wave as the received wave information.

The drive circuit 65 includes a circuit such as an H-Bridge circuit, and converts a rectangular pulse voltage supplied from the MCU 64 into a driving voltage of the ultrasonic transmitting element 41. The drive circuit 65 supplies the rectangular pulse after the voltage conversion to the ultrasonic transmitting element 41. Therefore, the ultrasonic transmitting element 41 generates an ultrasonic wave and outputs the ultrasonic wave in a predetermined orientation.

The amplifier circuit 66 amplifies the ultrasonic wave received by the ultrasonic receiving element 42. The amplifier circuit 66 may amplify the received ultrasonic wave in all bands, or may extract only a frequency component near the resonance frequency of the ultrasonic transmitting element 41 by a band pass filter (BPF) or the like and amplify only the frequency component.

The operation controller 67 is connected to a body drive unit 68, a head drive unit 69, a leg drive unit 70, an arm drive unit 71, a hand drive unit 72, and a finger drive unit 73. In accordance with an instruction from the CPU 61, the operation controller 67 controls the body drive unit 68, the head drive unit 69, the leg drive unit 70, the arm drive unit 71, the hand drive unit 72, and the finger drive unit 73, and causes the robot 11 to perform a predetermined operation.

The body drive unit 68, the head drive unit 69, the leg drive unit 70, the arm drive unit 71, the hand drive unit 72, and the finger drive unit 73 drive the body portion 21, the head portion 22, the leg portion 23, the arm portion 24, the hand portion 25, and the finger portions 26a and 26b under the control of the operation controller 67, respectively, and cause these portions to perform predetermined operations.

For example, the body drive unit 68 drives the body portion 21 to incline the body portion 21 forward, backward, left, and right. The head drive unit 69 drives the head portion 22, and rotates the head portion 22 relative to the body portion 21 such that the eye portion 22a and the ear portions 22b can acquire information from desired directions, and the mouth portion 22c can output voice in a desired direction. The leg drive unit 70 drives the wheels 31 of the leg portion 23 to move the robot 11 from a transport source to the transport destination. The arm drive unit 71 drives the arm portion 24 to move the arm portion 24 up, down, left, and right relative to the body portion 21 such that positions of the finger portions 26a and 26b are at desired positions (for example, positions where the target object can be gripped). The hand drive unit 72 drives the hand portion 25 to rotate the hand portion 25 relative to the arm portion 24 such that positions of finger portions 26a and 26b are at desired positions (for example, positions where the target object can be gripped). The finger drive unit 73 drives the finger portions 26a and 26b to cause the finger portions 26a and 26b to grip the target object.

The body drive unit 68, the head drive unit 69, the leg drive unit 70, the arm drive unit 71, the hand drive unit 72, and the finger drive unit 73 supply information such as current positions of the body portion 21, the head portion 22, the arm portion 24, the hand portion 25, and the finger portions 26a and 26b to the operation controller 67.

Furthermore, an input/output interface 75 is also connected to the bus 74. To the input/output interface 75, an input unit 76, an output unit 77, a storage unit 78, a communication unit 79, and a drive 80 are connected.

The input unit 76 includes the eye portion 22a, the ear portions 22b, and the like. The eye portion 22a acquires a surrounding image. The ear portions 22b acquire surrounding voice. The image acquired by the eye portion 22a and the voice acquired by the ear portions 22b are supplied to the CPU 61 via the input/output interface 75 and the bus 74.

The output unit 77 includes the mouth portion 22c and the like. The mouth portion 22c outputs voice supplied from the CPU 61 via the input/output interface 75 and the bus 74.

The storage unit 78 includes a hard disk, and a non-volatile memory. The communication unit 79 includes a network interface. The drive 80 drives a removable medium 81 such as a magnetic disk, an optical disk, a magneto-optical disk, or a semiconductor memory.

In the robot 11 configured as described above, for example, the CPU 61 loads the program stored in the storage unit 78 into the RAM 63 via the input/output interface 75 and the bus 74 and executes the program, to thereby perform a series of processes.

The program executed by the CPU 61 can be provided, for example, by recording on the removable medium 81 as a package medium and the like, for example. Furthermore, the program can be provided via a wired or wireless transmission medium such as a local area network, the Internet, or digital satellite broadcasting.

In the robot 11, the program can be installed in the storage unit 78 via the input/output interface 75 by mounting the removable medium 81 to the drive 80.

Furthermore, the program can be received by the communication unit 79 via a wired or wireless transmission medium, and installed in the storage unit 78. In addition, the program can be installed in the ROM 62 or the storage unit 78 in advance.

### <First Configuration Example of Arrangement Processing Unit>

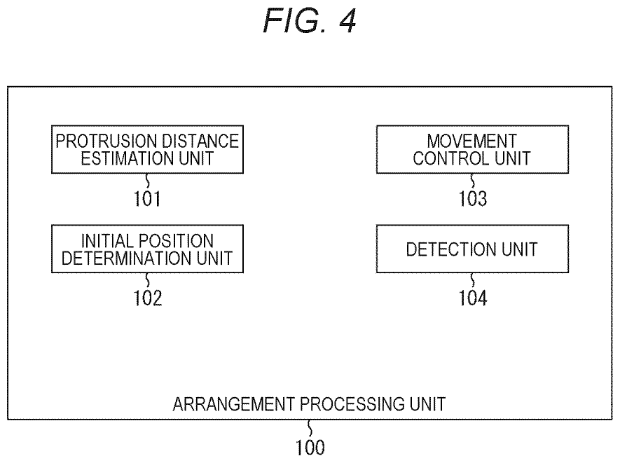

FIG. 4 is a block diagram illustrating a functional configuration example of an arrangement processing unit that performs the arrangement process of the CPU 61 in FIG. 3.

As illustrated in FIG. 4, an arrangement processing unit 100 includes a protrusion distance estimation unit 101, an initial position determination unit 102, a movement control unit 103, and a detection unit 104.

The protrusion distance estimation unit 101 instructs the operation controller 67 to move an interval between the finger portions 26a and 26b to a predetermined width W₀. Then, the protrusion distance estimation unit 101 instructs the MCU 64 to perform ultrasonic sensing, and acquires a reception time t₀ of an ultrasonic wave from the MCU 64. The protrusion distance estimation unit 101 stores the reception time t₀ and the width W₀ in association with each other in the RAM 63. The protrusion distance estimation unit 101 performs the above processing while changing the width W₀, and stores a table in which the reception times t₀ and the widths W₀ are associated with each other in the RAM 63.

The protrusion distance estimation unit 101 reads the reception time t₀ corresponding to the width W₀ the same as an interval W₁, which is supplied from the movement control unit 103, between the finger portions 26a and 26b when the finger portions 26a and 26b grip the target object from the table stored in the RAM 63. Then, the protrusion distance estimation unit 101 instructs the MCU 64 to perform ultrasonic sensing, and acquires a reception time t₁ of an ultrasonic wave from the MCU 64. The protrusion distance estimation unit 101 estimates a protrusion distance d of the target object on the basis of the reception time t₀ and the reception time t₁ according to the principle of time of flight (ToF), and supplies the protrusion distance d to the initial position determination unit 102. The protrusion distance estimation unit 101 supplies the protrusion distance d and the reception time t₁ to the detection unit 104.

The initial position determination unit 102 determines a position on the arrangement surface on which the target object is to be arranged on the basis of the image from the eye portion 22a and the like. On the basis of such a position and the protrusion distance d, the initial position determination unit 102 determines initial positions of the finger portions 26a and 26b at the time of an arrangement operation to be positions higher by (d+α) than a position on the arrangement surface on which the target object is to be arranged. Note that α is any value larger than zero, and is a margin determined in advance on the basis of estimation accuracy of the protrusion distance d. The initial position determination unit 102 supplies the initial positions to the movement control unit 103.

The movement control unit 103 acquires an image of the target object acquired by the eye portion 22a, and determines an objective gripping position that is a gripping position of the target object aimed on the basis of the image. The movement control unit 103 calculates positions of the finger portions 26a and 26b that enable the finger portions 26a and 26b to grip the objective gripping position on the basis of the objective gripping position. The movement control unit 103 instructs the operation controller 67 to move the finger portions 26a and 26b to the positions.

Then, the movement control unit 103 instructs the operation controller 67 to cause the finger portions 26a and 26b to grip the target object. As a result, the movement control unit 103 acquires an interval between the finger portions 26a and 26b when the target object is gripped from the operation controller 67, and supplies the interval to the protrusion distance estimation unit 101. The movement control unit 103 instructs the operation controller 67 to lift the target object gripped by the finger portions 26a and 26b.

The movement control unit 103 instructs the operation controller 67 to move the finger portions 26a and 26b to the initial positions supplied from the initial position determination unit 102. Then, the movement control unit 103 notifies the detection unit 104 of the completion of the movement. Thereafter, the movement control unit 103 instructs the operation controller 67 to move the finger portions 26a and 26b from the initial positions toward the arrangement surface at a predetermined speed. The movement control unit 103 instructs the operation controller 67 to stop the movement of the finger portions 26a and 26b and to release the target object from the finger portions 26a and 26b according to a detection result from the detection unit 104.

The detection unit 104 calculates a predetermined period corresponding to the maximum voltage on the basis of the protrusion distance d supplied from the protrusion distance estimation unit 101 and the reception time t₁. In response to the notification from the movement control unit 103, the detection unit 104 starts the instruction of ultrasonic sensing with respect to the MCU 64 and provides notification of the predetermined period corresponding to the maximum voltage, and as a result, acquires a maximum voltage Vₘₐₓ from the MCU 64. The detection unit 104 detects that the target object has come into contact with the arrangement surface on the basis of the maximum voltage Vₘₐₓ. The detection unit 104 supplies such a detection result to the movement control unit 103, and ends the instruction of ultrasonic sensing with respect to the MCU 64.

### <Description of Outline of First Example of Arrangement Process>

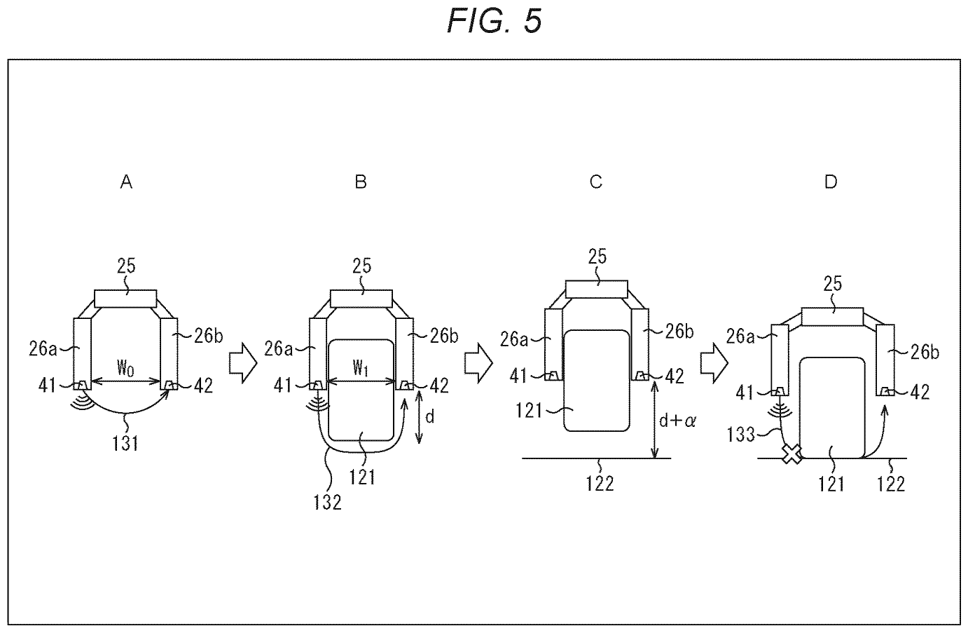

FIG. 5 is a view illustrating an outline of an arrangement process performed by the arrangement processing unit 100 in FIG. 4.

First, as illustrated in A of FIG. 5, an interval between the finger portions 26a and 26b is set to the predetermined width W₀ in response to an instruction of the protrusion distance estimation unit 101 in a state where the finger portions 26a and 26b do not grip anything before the arrangement process. Then, ultrasonic sensing using the ultrasonic transmitting element 41 and the ultrasonic receiving element 42 is performed in response to the instruction from the protrusion distance estimation unit 101. As a result, the protrusion distance estimation unit 101 acquires the reception time t₀ of an ultrasonic wave received through a path 131 directly directed from the ultrasonic transmitting element 41 to the ultrasonic receiving element 42. The above is performed while changing the width W₀, and the protrusion distance estimation unit 101 stores the table in which the reception time t₀ and the width W₀ are associated with each other in the RAM 63.

Next, the arrangement process is started, and the finger portions 26a and 26b grip an objective gripping position of a target object 121 in response to an instruction from the movement control unit 103 as illustrated in B of FIG. 5. Then, the protrusion distance estimation unit 101 reads the reception time t₀ corresponding to the width W₀ the same as the interval W₁ between the finger portions 26a and 26b at this time from the table stored in the RAM 63.

After the target object 121 is gripped, ultrasonic sensing using the ultrasonic transmitting element 41 and the ultrasonic receiving element 42 is performed in response to an instruction from the protrusion distance estimation unit 101. As a result, the protrusion distance estimation unit 101 acquires the reception time t₁ of an ultrasonic wave received by the ultrasonic receiving element 42 through a path 132 directed from the ultrasonic transmitting element 41 toward the ultrasonic receiving element 42 while making a detour around the target object 121. The protrusion distance estimation unit 101 estimates the protrusion distance d of the target object 121 on the basis of the reception time t₀ and the reception time t₁.

Specifically, since sound has a diffraction effect, even in a case where the target object 121 is present between the ultrasonic transmitting element 41 and the ultrasonic receiving element 42, an ultrasonic wave makes a detour around the target object 121 and propagates through the path 132. At this time, the reception time t₁ varies depending on the protrusion distance d and the interval W₁ between the finger portions 26a and 26b, but the interval W₁ is unknown until the finger portions 26a and 26b grip the target object 121. Therefore, the protrusion distance estimation unit 101 holds in advance the table in which various widths W₀ are associated with the reception times t₀. Then, the protrusion distance estimation unit 101 estimates the protrusion distance d by the following Formula (1) on the basis of the reception time t₀ corresponding to the same width W₀ as the interval W₁ acquired after the gripping of the target object 121 and the reception time t₁.

$$\begin{matrix}[ Math . 1 ] & \\ d = \frac{v ( {t}_{1} - {t}_{0} )}{2} & ( 1 )\end{matrix}$$

In Formula (1), v represents a sound velocity. According to Formula (1), the protrusion distance d is estimated by subtracting a distance v×t₀ of the path 132 through which direct propagation is performed without making a detour around the target object 121 from a distance v×t₁ of the path 131 detouring around the target object 121, and dividing the resultant by two. The interval W₁ may be used instead of the distance v×t₀.

After the protrusion distance d is estimated, the initial position determination unit 102 determines initial positions of the finger portion 26a and the finger portion 26b in an arrangement operation to be positions higher by (d+α) than a position on an arrangement surface 122 on which the target object is to be arranged on the basis of the positions on the arrangement surface on which the target object is to be arranged and the protrusion distance d. Therefore, the finger portions 26a and 26b move to the initial positions in accordance with an instruction from the movement control unit 103 as illustrated in C of FIG. 5. As described above, the initial position determination unit 102 determine the initial positions not to be positions higher by d than the position on the arrangement surface 122 on which the target object is to be arranged, but to be even higher positions by the margin. Therefore, the finger portions 26a and 26b can be moved to the initial positions at a high speed without causing the target object 121 to collide with the arrangement surface 122.

After the finger portions 26a and 26b are moved to the initial positions, the finger portions 26a and 26b are moved from the initial positions toward the arrangement surface 122 at a predetermined speed in response to an instruction of the movement control unit 103. At this time, in response to an instruction from the detection unit 104, ultrasonic sensing using the ultrasonic transmitting element 41 and the ultrasonic receiving element 42 is performed.

The detection unit 104 detects that the target object 121 has come into contact with the arrangement surface 122 on the basis of the maximum voltage Vₘₐₓ obtained as a result of the ultrasonic sensing. Specifically, immediately before the target object 121 comes into contact with the arrangement surface 122, a gap between a surface (a bottom surface in the example of FIG. 5) of the target object 121 on a side closer to the arrangement surface 122 and the arrangement surface 122 decreases as illustrated in D of FIG. 5. Therefore, the maximum voltage Vₘₐₓ of the ultrasonic wave received by the ultrasonic receiving element 42 through a path 133 passing through the gap decreases. Thus, when the maximum voltage Vₘₐₓ of the ultrasonic wave is smaller than a predetermined threshold Vₜₕ, the detection unit 104 detects that the target object 121 has come into contact with the arrangement surface 122.

When the detection unit 104 detects that the target object 121 has come into contact with the arrangement surface 122, the movement control unit 103 stops the movement of the finger portions 26a and 26b, and the target object 121 is released from the finger portions 26a and 26b.

Therefore, it is possible to prevent the finger portions 26a and 26b from moving toward the arrangement surface 122 (descending in the example of FIG. 5) even after the target object 121 comes into contact with the arrangement surface 122 so as not to press the target object 121 into the arrangement surface 122 and apply an excessive force to the target object 121. Furthermore, it is possible to prevent the target object 121 from being damaged due to the release of the target object 121 before the target object 121 comes into contact with the arrangement surface 122. That is, the target object 121 can be suitably arranged on the arrangement surface 122.

### <Description of Detection Method in Detection Unit>

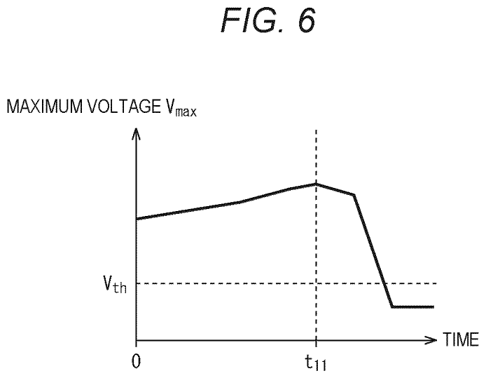

FIG. 6 is a view illustrating a detection method for detecting that a target object has come into contact with an arrangement surface in the detection unit 104 in FIG. 4.

In a graph of FIG. 6, a horizontal axis represents a time elapsed from a start of movement of the finger portions 26a and 26b from initial positions to the arrangement surface. A vertical axis represents the maximum voltage Vₘₐₓ of an ultrasonic wave received by the ultrasonic receiving element 42.

As illustrated in FIG. 6, when the movement of the finger portions 26a and 26b from the initial positions to the arrangement surface is started, a reflected wave of an ultrasonic wave from the arrangement surface becomes strong, so that the maximum voltage Vₘₐₓ increases until time t₁₁ immediately before the target object comes into contact with the arrangement surface. However, after the time t₁₁, a gap between a surface of the target object on a side closer to the arrangement surface and the arrangement surface decreases, and thus, the maximum voltage Vₘₐₓ of the ultrasonic wave received by the ultrasonic receiving element 42 through the gap starts to decrease. When the maximum voltage Vₘₐₓ becomes smaller than the threshold Vₜₕ, the detection unit 104 detects that the target object has come into contact with the arrangement surface.

### <Description of Experimental Results>

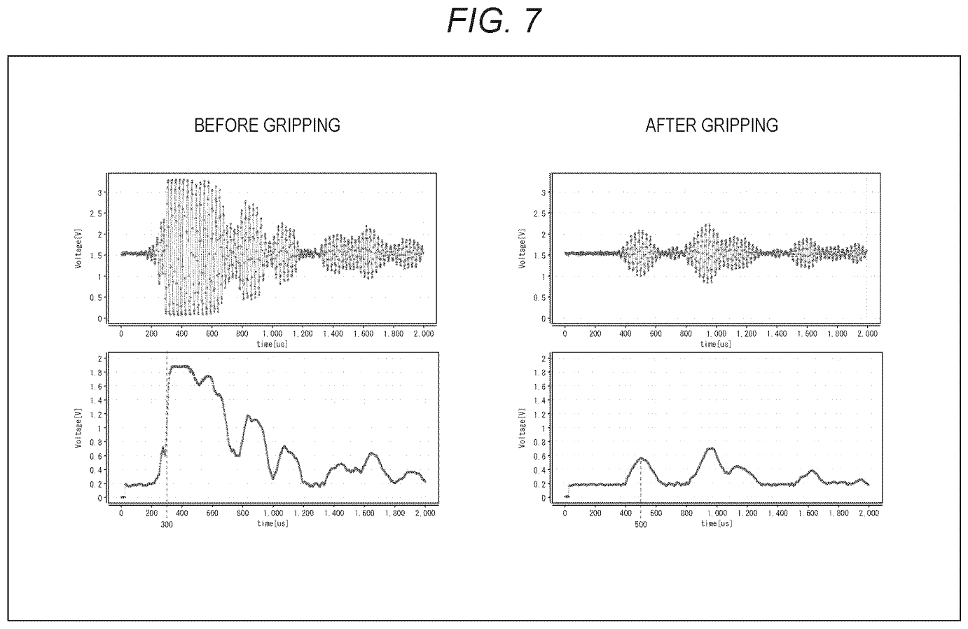

FIGS. 7 to 10 are views illustrating experimental results related to the arrangement process.

In graphs of FIGS. 7 to 10, a horizontal axis represents a time elapsed from the time when the ultrasonic transmitting element 41 outputs an ultrasonic wave, and a vertical axis represents a digital signal of a voltage corresponding to a sound pressure of the ultrasonic wave received by the ultrasonic receiving element 42. Upper graphs in FIGS. 7 to 10 represent ultrasonic waveforms of ultrasonic waves received by the ultrasonic receiving element 42, and lower graphs represent envelopes of the ultrasonic waveforms.

Note that experiments in FIGS. 7 to 10 were performed simply by placing the ultrasonic transmitting element 41 and the ultrasonic receiving element 42 to face upward, directly interposing a target object, and lowering a plate serving as an arrangement surface from above toward the target object.

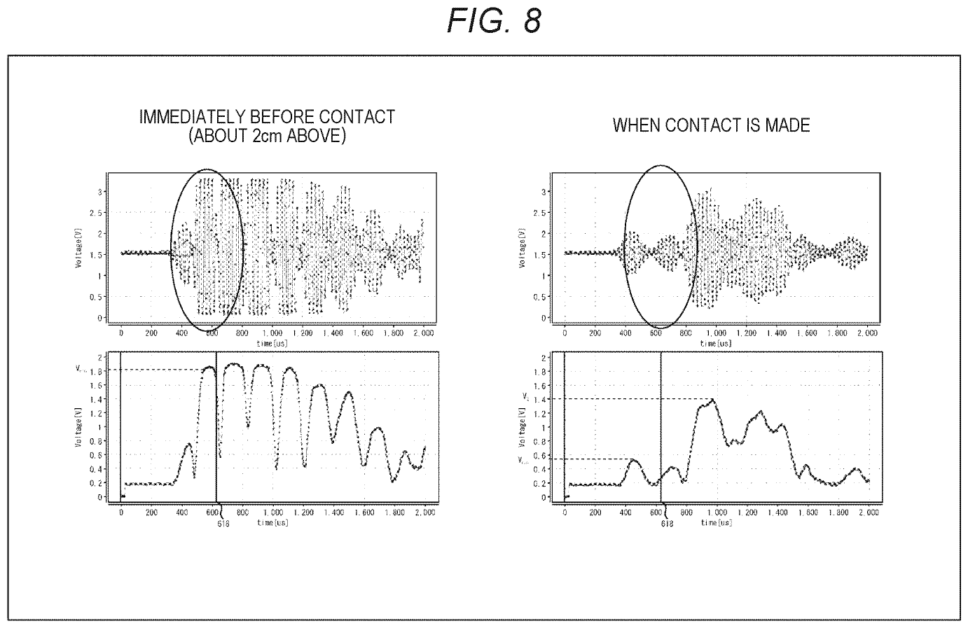

In FIGS. 7 and 8, the target object is a rectangular parallelepiped box having a width of 25 mm between gripping positions and a height of 60 mm. An actual measurement value of the protrusion distance d is 35 mm, and an actual measurement value of the interval W₁ is 40 mm. Therefore, an actual measurement value of a length of a path of an ultrasonic wave when the target object is gripped is a value obtained by adding the actual measurement value of the interval W₁ to twice the actual measurement value of the protrusion distance d, and is 110 mm (=35×2+40).

Graphs on the left side of FIG. 7 illustrate ultrasonic waveforms and an envelope of the ultrasonic waveforms when an interval between the ultrasonic transmitting element 41 and the ultrasonic receiving element 42 is set to an interval the same as that when the target object is gripped before gripping of the target object. As illustrated in the graphs on the left side of FIG. 7, the reception time t₀ at this time is about 300 μs.

Graphs on the right side of FIG. 7 illustrate ultrasonic waveforms and an envelope of the ultrasonic waveforms when the plate serving as the arrangement surface is sufficiently away from the target object after gripping of the target object. As illustrated in the graphs on the right side of FIG. 7, the reception time t₁ at this time is about 500 μs.

Therefore, when the protrusion distance d is calculated with the reception time t₀ as 300 μs, the reception time t₁ as 500 μs, and the sound velocity v as 340 m/s in Formula (1) described above, an estimation value of the protrusion distance d is 34 mm.

Graphs on the left side of FIG. 8 illustrate ultrasonic waveforms and an envelope of the ultrasonic waveforms when the plate serving as the arrangement surface is lowered from above toward the target object and is located about 2 cm above the target object, that is, when a state in which the target object is moved from an initial position toward the arrangement surface and is located about 2 cm above the arrangement surface is assumed. A maximum value of a voltage is saturated in ultrasonic waveforms included in an ellipse of the graph on the left side of FIG. 8. That is, there is a sufficient gap between the plate serving as the arrangement surface and the target object, and most of an ultrasonic wave reflected from the plate through the gap and an ultrasonic wave detouring around the target object are received by the ultrasonic receiving element 42.

Graphs on the right side of FIG. 8 illustrate ultrasonic waveforms and an envelope of the ultrasonic waveforms when the plate serving as the arrangement surface is further lowered toward the target object and comes into contact with the target object, that is, when a state in which the target object further approaches the arrangement surface and comes into contact with the arrangement surface is assumed. Ultrasonic waveforms included in an ellipse of the graph on the right side of FIG. 8 is attenuated as compared with the case of the graph on the left side of FIG. 8. That is, since there is no sufficient gap between the plate serving as the arrangement surface and the target object, an ultrasonic wave output from the ultrasonic transmitting element 41 is blocked, and it is difficult for the ultrasonic receiving element 42 to receive the ultrasonic wave. Therefore, it can be seen that the detection unit 104 can detect that the target object has come into contact with the arrangement surface when the maximum voltage Vₘₐₓ, that is, a maximum value of amplitudes of ultrasonic waveforms in a predetermined period is smaller than the threshold Vₜₕ.

Here, the predetermined period corresponding to the maximum voltage Vₘₐₓ will be described. The graphs of FIG. 8 illustrate the ultrasonic waveforms for 2 ms after the ultrasonic transmitting element 41 outputs an ultrasonic wave, but the ultrasonic waveforms in the entire period include an ultrasonic waveform of an ultrasonic wave other than an ultrasonic wave propagated through the gap between the target object and the arrangement surface. Therefore, there is a case where a maximum value of a voltage in the ultrasonic waveforms in the entire period of FIG. 8 is not smaller than the threshold Vₜₕ even when the target object comes into contact with the arrangement surface. In this regard, the detection unit 104 limits a period for searching for the maximum value of the voltage, that is, a period corresponding to the maximum voltage Vₘₐₓ.

Specifically, the predetermined period corresponding to the maximum voltage Vₘₐₓ is a period from the time when the ultrasonic transmitting element 41 outputs the ultrasonic wave to time t₂ calculated by the following Formula (2).

$$\begin{matrix}[ Math . 2 ] & \\ {t}_{2} = {t}_{1} + \frac{2 α}{v} & ( 2 )\end{matrix}$$

According to Formula (2), the time t₂ is obtained by adding a time taken for the ultrasonic wave to move by a distance twice the margin α to the reception time t₁ when the finger portions 26a and 26b grip the target object. That is, the time t₂ is a value obtained by estimating a reception time in a case where the finger portions 26a and 26b are located at the initial positions on the basis of the reception time t₁, the margin α, and the sound velocity v.

When the finger portions 26a and 26b move from the initial positions toward the arrangement surface, a distance between the arrangement surface and each of the ultrasonic transmitting element 41 and the ultrasonic receiving element 42 decreases. Therefore, the ultrasonic wave propagated through the gap between the target object and the arrangement surface is received by the ultrasonic receiving element 42 at a time earlier than the time t₂. Thus, erroneous detection by the detection unit 104 can be prevented by limiting the period corresponding to the maximum voltage Vₘₐₓ to the period from the time when the ultrasonic transmitting element 41 outputs the ultrasonic wave output to the time t₂.

For example, assuming that α is 2 cm and the sound velocity v is 340 m/s in FIG. 8, the reception time t₁ is about 500 μs as described above, and thus, the time t₂ calculated by Formula (2) is about 618 μs. In the graphs on the left side of FIG. 8, a maximum value of a voltage is saturated at about 550 μs. Therefore, a maximum value of a voltage in the ultrasonic waveforms for 2 ms after the ultrasonic transmitting element 41 outputs the ultrasonic wave is substantially the same as the maximum voltage Vₘₐₓ, which is a maximum value of a voltage in the ultrasonic waveforms for about 618 μs after the ultrasonic transmitting element 41 outputs the ultrasonic wave.

However, in the graphs on the right side of FIG. 8, a maximum value V₂ of a voltage in the ultrasonic waveforms for 2 ms after the ultrasonic transmitting element 41 outputs the ultrasonic wave is larger than the maximum voltage Vₘₐₓ, which is a maximum value of a voltage in the ultrasonic waveforms for about 618 μs after the ultrasonic transmitting element 41 outputs the ultrasonic wave. Therefore, in a case where the period for the maximum voltage Vₘₐₓ is not limited, the detection unit 104 erroneously detects that the target object is not in contact with the arrangement surface on the basis of the maximum value V₂ when the maximum value V₂ is equal to or larger than the threshold Vₜₕ.

Therefore, the detection unit 104 limits the period for the maximum voltage Vₘₐₓ between the output of the ultrasonic wave from the ultrasonic transmitting element 41 and the time t₂ (in this case, about 618 μs) to be capable of detecting that the target object is in contact with the arrangement surface on the basis of the maximum voltage Vₘₐₓ.

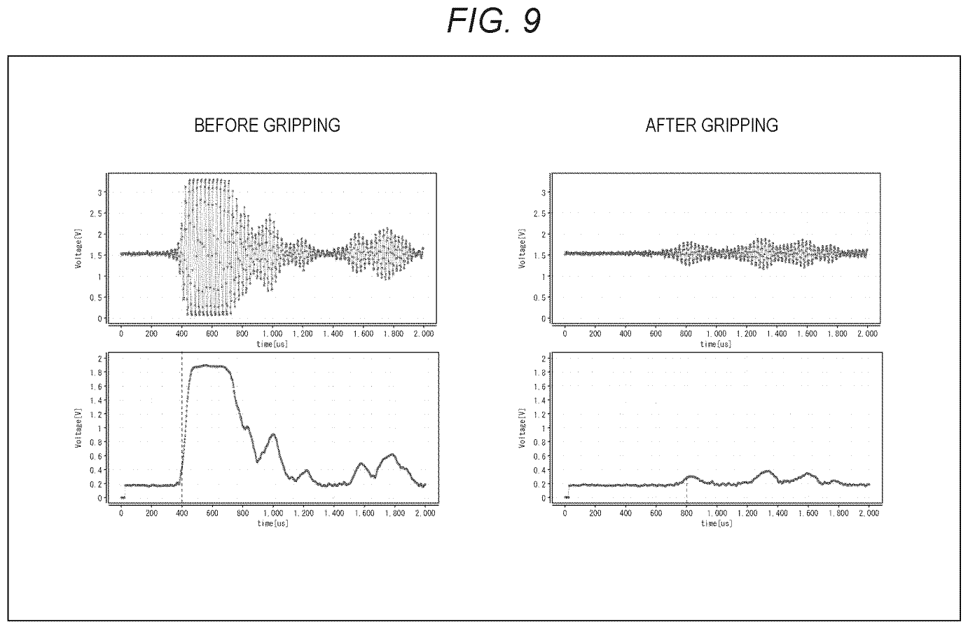

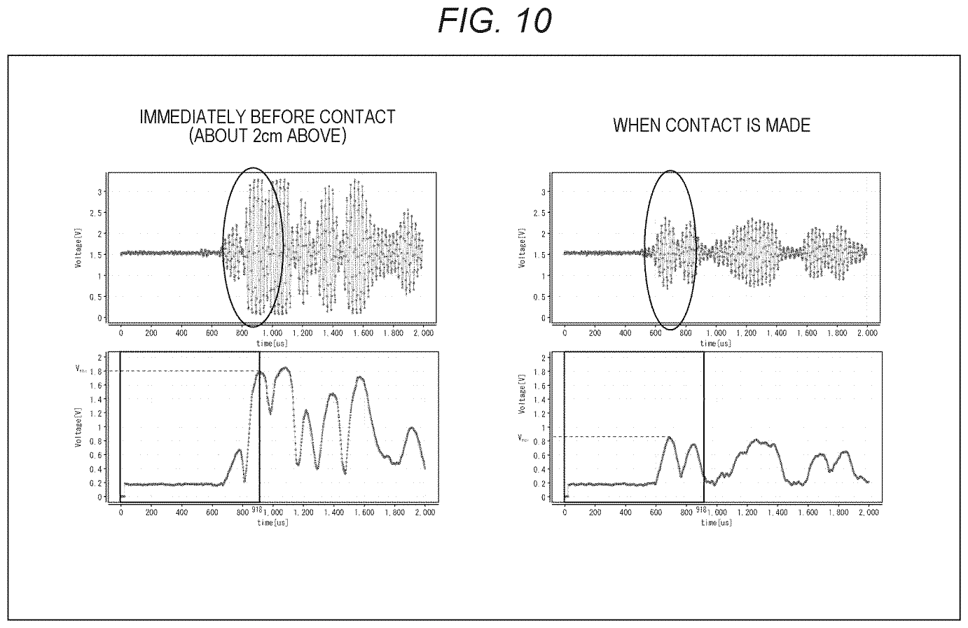

In FIGS. 9 and 10, a target object is a cylindrical cup having a diameter of 75 mm and a height of 85 mm. An actual measurement value of the protrusion distance d is 60 mm, and an actual measurement value of the interval W₁ is 90 mm. Therefore, an actual measurement value of a length of a path of an ultrasonic wave when the target object is gripped is a value obtained by adding the actual measurement value of the interval W₁ to twice the actual measurement value of the protrusion distance d, and is 210 mm (=60×2+90).

Graphs on the left side of FIG. 9 illustrate ultrasonic waveforms and an envelope of the ultrasonic waveforms when an interval between the ultrasonic transmitting element 41 and the ultrasonic receiving element 42 is set to an interval the same as that when the target object is gripped before gripping of the target object. As illustrated in the graphs on the left side of FIG. 9, the reception time t₀ at this time is about 400 μs.

Graphs on the right side of FIG. 9 illustrate ultrasonic waveforms and an envelope of the ultrasonic waveforms when the plate serving as the arrangement surface is sufficiently away from the target object after gripping of the target object. As illustrated in the graphs on the right side of FIG. 9, the reception time t₁ at this time is about 800 μs.

Therefore, when the protrusion distance d is calculated with the reception time t₀ as 400 μs, the reception time t₁ as 800 μs, and the sound velocity v as 340 m/s in Formula (1) described above, an estimation value of the protrusion distance d is 68 mm.

Similarly to the graphs on the left side of FIG. 8, graphs on the left side of FIG. 10 illustrate ultrasonic waveforms and an envelope of the ultrasonic waveforms when a state in which the target object moves from an initial position toward the arrangement surface and is located about 2 cm above the arrangement surface is assumed. A maximum value of a voltage is saturated in ultrasonic waveforms included in an ellipse of the graph on the left side of FIG. 10, similarly to the graph on the left side of FIG. 8.

Graphs on the right side of FIG. 10 illustrate ultrasonic waveforms and an envelope of the ultrasonic waveforms when a state in which the target object further approaches the arrangement surface and comes into contact with the arrangement surface is assumed, similarly to the graphs on the right side of FIG. 8. Ultrasonic waveforms included in an ellipse of the graph on the right side of FIG. 10 is attenuated as compared with the case of the graph on the left side of FIG. 10, similarly to the case of FIG. 8. Therefore, it can be seen that the detection unit 104 can detect that the target object has come into contact with the arrangement surface when the maximum voltage Vₘₐₓ is smaller than the threshold Vₜₕ.

Note that the predetermined period corresponding to the maximum voltage Vₘₐₓ is a period from the time when the ultrasonic transmitting element 41 outputs an ultrasonic wave to time t₂. For example, assuming that α is 2 cm and the sound velocity v is 340 m/s in FIG. 10, the reception time t₁ is about 800 μs as described above, and thus, the time t₂ calculated by Formula (2) is about 918 μs.

In the graphs on the left side of FIG. 10, the maximum value of the voltage is saturated at about 918 μs. Therefore, a maximum value of a voltage in the ultrasonic waveforms for 2 ms after the ultrasonic transmitting element 41 outputs the ultrasonic wave is substantially the same as the maximum voltage Vₘₐₓ, which is a maximum value of a voltage in the ultrasonic waveforms for about 918 μs after the ultrasonic transmitting element 41 outputs the ultrasonic wave. On the other hand, in the graphs on the right side of FIG. 10, a maximum value of a voltage is not saturated, but a voltage exceeding the maximum voltage Vₘₐₓ, which is the maximum value of the voltage in the ultrasonic waveforms for about 918 μs, does not appear after about 918 μs since the output of the ultrasonic wave from the ultrasonic transmitting element 41. Therefore, the maximum value of the voltage in the ultrasonic waveform for 2 ms after the ultrasonic transmitting element 41 outputs the ultrasonic wave is the same as the maximum voltage Vₘₐₓ.

As described above, in the experimental results illustrated in FIG. 7, the estimation value is 30 mm while the actual measurement value of the protrusion distance d is 35 mm. Furthermore, in the experimental result illustrated in FIG. 9, the estimation value is 68 mm while the actual measurement value of the protrusion distance d is 60 mm. Therefore, it can be said that the protrusion distance d can be estimated with high accuracy within 10 mm by an estimation method in the protrusion distance estimation unit 101. Note that the protrusion distance estimation unit 101 may further improve the estimation accuracy of the protrusion distance d by performing calibration on the basis of an estimation value and an actual measurement value of the protrusion distance d.

### <Description of Flow of First Example of Arrangement Process Performed by Arrangement Processing Unit>

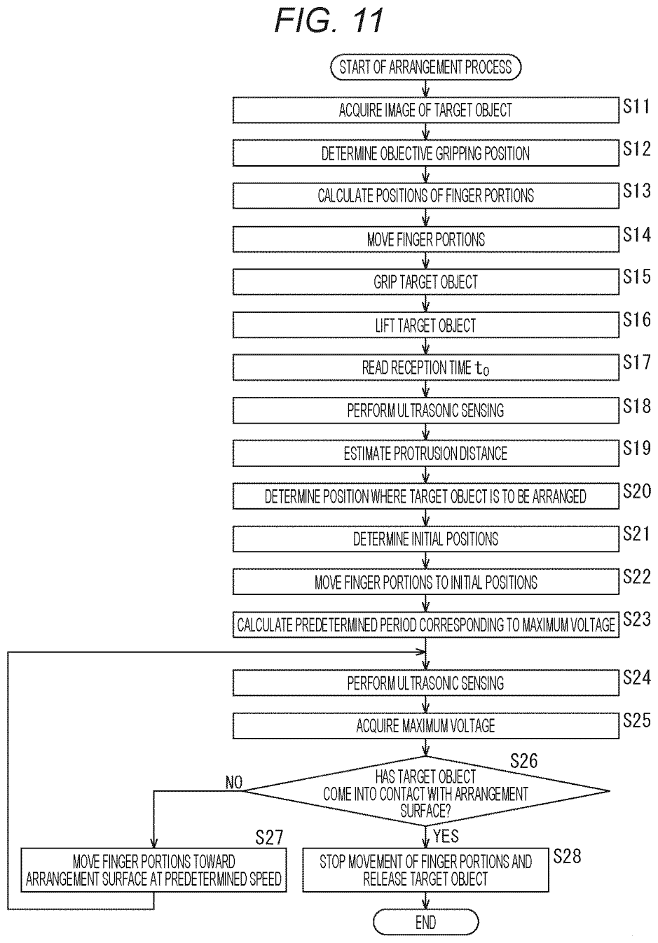

FIG. 11 is a flowchart illustrating a flow of the arrangement process performed by the arrangement processing unit 100 in FIG. 4. This arrangement process is started, for example, when the robot 11 places a target object on the tray portion 32 and moves to a transport destination.

In step S11 of FIG. 11, the movement control unit 103 acquires an image of the target object acquired by the eye portion 22a. In step S12, the movement control unit 103 determines an objective gripping position on the basis of the image acquired in step S11.

In step S13, the movement control unit 103 calculates positions of the finger portions 26a and 26b that enable the finger portions 26a and 26b to grip the objective gripping position on the basis of the objective gripping position determined in step S12.

In step S14, the movement control unit 103 instructs the operation controller 67 to move the finger portions 26a and 26b to the positions calculated in step S12.

In step S15, the movement control unit 103 instructs the operation controller 67 to cause the finger portions 26a and 26b to grip the objective gripping position of the target object. Then, the movement control unit 103 acquires the interval W₁ between the finger portions 26a and 26b from the operation controller 67, and supplies the interval W₁ to the protrusion distance estimation unit 101.

In step S16, the movement control unit 103 instructs the operation controller 67 to cause the finger portion 26a and the finger portion 26b to lift the target object. A gripping operation is performed by the processing from steps S11 to S16.

In step S17, the protrusion distance estimation unit 101 reads the reception time t₀ corresponding to the width W₀ the same as the interval W₁ supplied from the movement control unit 103 from the table stored in the RAM 63.

In step S18, the protrusion distance estimation unit 101 instructs the MCU 64 to perform ultrasonic sensing. The protrusion distance estimation unit 101 acquires the reception time t₁ obtained as a result from the MCU 64.

In step S19, the protrusion distance estimation unit 101 estimates the protrusion distance d on the basis of the reception time t₀ read in step S17 and the reception time t₁ acquired in step S18. The protrusion distance estimation unit 101 supplies the protrusion distance d to the initial position determination unit 102, and supplies the protrusion distance d and the reception time t₁ to the detection unit 104.

In step S20, the initial position determination unit 102 determines a position on the arrangement surface on which the target object is to be arranged on the basis of the image from the eye portion 22a and the like.

In step S21, on the basis of the position determined in step S20 and the protrusion distance d estimated in step S19, the initial position determination unit 102 determines initial positions of the finger portion 26a and the finger portion 26b to be positions higher by (d+α) than the position on the arrangement surface on which the target object is to be arranged.

In step S22, the movement control unit 103 instructs the operation controller 67 to move the finger portions 26a and 26b to the initial positions. Then, the movement control unit 103 notifies the detection unit 104 of the completion of the movement.

In step S23, the detection unit 104 calculates a predetermined period corresponding to the maximum voltage Vₘₐₓ on the basis of the protrusion distance d and the reception time t₁.

In step S24, the detection unit 104 instructs the MCU 64 to perform ultrasonic sensing in response to the notification from the movement control unit 103. At this time, the detection unit 104 notifies the MCU 64 of the predetermined period calculated in step S23. In step S25, the detection unit 104 acquires the maximum voltage Vₘₐₓ from the MCU 64.

In step S26, the detection unit 104 determines whether or not the target object has come into contact with the arrangement surface on the basis of the maximum voltage Vₘₐₓ acquired in step S25. Specifically, the detection unit 104 determines whether or not the maximum voltage Vₘₐₓ is smaller than the threshold Vₜₕ. Then, in a case where it is determined that the maximum voltage Vₘₐₓ is not smaller than the threshold Vₜₕ, the detection unit 104 determines that the target object is not in contact with the arrangement surface and advances the processing to step S27.

In step S27, the movement control unit 103 instructs the operation controller 67 to move the finger portions 26a and 26b toward the arrangement surface at a predetermined speed for a predetermined time. Then, the processing returns to step S24, and the detection unit 104 instructs the MCU 64 to perform ultrasonic sensing, and the processing proceeds to step S25.

On the other hand, in a case where it is determined that the maximum voltage Vₘₐₓ is smaller than the threshold Vₜₕ in step S26, the detection unit 104 determines that the target object has come into contact with the arrangement surface, and supplies a detection result indicating that the contact of the target object with the arrangement surface to the movement control unit 103. Then, the processing proceeds to step S28.

In step S28, the movement control unit 103 instructs the operation controller 67 according to the detection result from the detection unit 104 to stop the movement of the finger portions 26a and 26b and release the target object from the finger portions 26a and 26b. Then, the arrangement process ends. The arrangement operation is performed by the processing from steps S17 to S28.

<Description of Arrangement Process Performed without Using Present Technology>

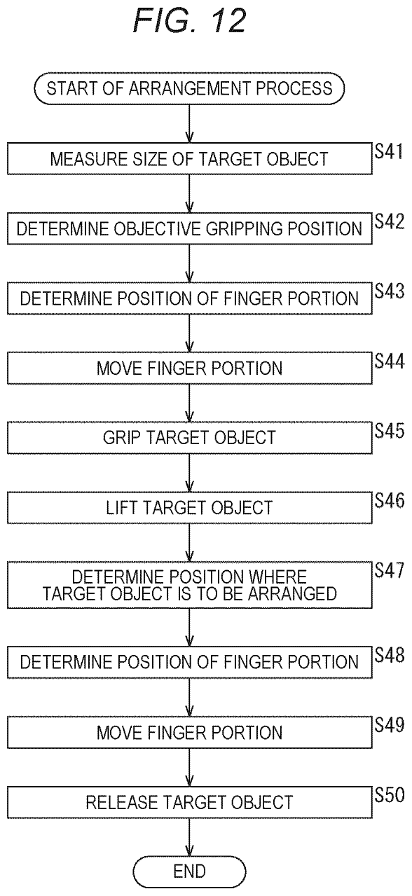

FIG. 12 is a flowchart illustrating an example of an arrangement process performed by a robot without using the present technology.

In step S41 of FIG. 12, the robot measures a size of a target object. As a method for measuring a size of a target object, for example, there is a method in which an image of a target object is acquired using a camera and a size of the target object is measured from an image of the target object extracted by performing an image segmentation process on the image. This method requires a high computational load. Furthermore, as a method for measuring a size of a target object, there is also a method in which a size of a target object is measured using a three-dimensional sensor such as a ToF sensor or a stereo camera. The robot needs to sense the target object regardless of which method is adopted. Therefore, in a case where a finger portion gripping the target object is present at a position where the finger portion obstructs the target object, the robot needs to move a camera or a three-dimensional sensor to a position where the target object can be sensed.

In step S42, the robot determines an objective gripping position on the basis of the size of the target object measured in step S41. In step S43, the robot determines a position of the finger portion at which the objective gripping position can be gripped by the finger portion on the basis of the objective gripping position determined in step S42.

In step S44, the robot moves the finger portion to the position determined in step S43. In step S45, the robot causes the finger portion to grip the objective gripping position of the target object. In step S46, the robot causes the finger portion to lift the target object. A gripping operation is performed by the processing from steps S41 to S46.

In step S47, the robot determines a position on an arrangement surface on which the target object is to be arranged. In step S48, the robot determines a position of the finger portion that enables the target object to be arranged at the position on the arrangement surface on the basis of the size of the target object measured in step S41, the objective gripping position, and the position on the arrangement surface determined in step S47. Specifically, the robot estimates a protrusion distance on the basis of the size of the target object and the objective gripping position. Then, the robot determines a position of the finger portion such that the finger portion is arranged to be higher by the protrusion distance than the position on the arrangement surface determined in step S47.

In step S49, the robot moves the finger portion to the position determined in step S48. In step S50, the robot releases the target object from the finger portion, and ends the arrangement process. An arrangement operation is performed by the processing from steps S47 to S50.

As described above, in the arrangement process of FIG. 12, the size of the target object is measured, and the protrusion distance is estimated on the basis of the size of the target object and the objective gripping position in order to suitably arrange the target object. However, there is a case where an error occurs in the estimation of the protrusion distance due to occurrence of an error in the measurement of the size of the target object or occurrence of an error between the objective gripping position and an actual gripping position.

In this case, when the robot arranges the finger portion to be higher by the protrusion distance than the position on the arrangement surface on which the target object is to be arranged and releases the target object, there is a possibility that the target object drops by being released in a state of not being in contact with the arrangement surface, or the target object is pressed against the arrangement surface by the finger portion moving toward the arrangement surface even after the target object comes into contact with the arrangement surface. When the target object drops, an impact is applied to the target object, or the target object moves or falls down after dropping so that the target object cannot be arranged at a desired position in a desired posture. When the target object is pressed against the arrangement surface even after the contact, there is a possibility that an excessive force is applied to the target object to damage the target object. Therefore, it is necessary to move the target object to the arrangement surface at a low speed in order to prevent the damage to the target object.

On the other hand, in the arrangement process of FIG. 11, the protrusion distance d is estimated after the target object is gripped, and thus, even in a case where an error occurs between the objective gripping position and an actual gripping position, the error does not affect an estimation error of the protrusion distance d. That is, the protrusion distance d can be estimated with high accuracy.

A calculation time required for the ultrasonic sensing is about 10 ms, and a computational load is low. Therefore, in the arrangement process of FIG. 11, the protrusion distance d can be estimated at a higher speed and with a lower load as compared with a case where the size of the target object is measured using the image segmentation process and the protrusion distance is estimated on the basis of the size and the objective gripping position as in the arrangement process of FIG. 12.

In the arrangement process of FIG. 11, the initial positions of the finger portions 26a and 26b are above the arrangement surface by the margin α with respect to the protrusion distance d, and thus, there is no possibility that the target object collides with the arrangement surface when the finger portions 26a and 26b are moved to the initial positions. Therefore, the finger portions 26a and 26b can be moved at a high speed to be located above the position on the arrangement surface on which the target object is to be arranged.

In the arrangement process of FIG. 11, the target object is released after the contact of the target object with the arrangement surface is detected, there is no possibility that the target object drops. The arrangement process of FIG. 11 is basically similar to the arrangement process of FIG. 12 except for the method for estimating the protrusion distance, the presence or absence of detection of contact of the target object with the arrangement surface, and the like. Therefore, it is possible to switch from another arrangement process such as the arrangement process of FIG. 12 to the arrangement process of FIG. 11 with a short takt time.

As described above, in a case where the target object gripped by the finger portion 26a having the ultrasonic transmitting element 41 and the finger portion 26b having the ultrasonic receiving element 42 is to be arranged on the arrangement surface, the arrangement processing unit 100 detects contact of the target object with the arrangement surface on the basis of the sound pressure of the ultrasonic wave received by the ultrasonic receiving element 42.

Therefore, the arrangement processing unit 100 can easily detect the contact of the target object with the arrangement surface and suitably and easily arrange the target object only by performing the ultrasonic sensing. The arrangement processing unit 100 does not need to capture an image of the arrangement surface in order to detect the contact of the target object with the arrangement surface. Therefore, the arrangement processing unit 100 can accurately detect contact of the target object with the arrangement surface even in a case where the arrangement surface is present at a place (for example, inside a shelf at a high place or a low place, behind a shield, or the like) where image capturing with the eye portion 22a or the like is impossible. As a result, the target object can be suitably arranged at a high speed.

Since the arrangement processing unit 100 estimates the protrusion distance d on the basis of the sound pressure of the ultrasonic wave received by the ultrasonic receiving element 42, it is possible to easily estimate the protrusion distance d without performing a complicated process such as the image segmentation process.

Note that the predetermined period corresponding to the maximum voltage may be changed in accordance with current positions of the finger portions 26a and 26b. In this case, for example, the predetermined period corresponding to the maximum voltage is a period from the time when the ultrasonic transmitting element 41 outputs an ultrasonic wave to time t₃ calculated by the following Formula (3).

$$\begin{matrix}[ Math . 3 ] & \\ {t}_{3} = {t}_{1} + \frac{2 ( α - Δ z )}{v} & ( 3 )\end{matrix}$$

In the Formula (3), Δz is a distance between the initial position and the current position of each of the finger portions 26a and 26b, and is a value that is equal to or more than zero and less than α.

The table in which the reception times t₀ and the widths W₀ are associated with each other may be created immediately before the arrangement process, or may be created when the robot 11 is activated or the like. This table may be created at the time of shipment of the robot 11 from a factory and stored in the storage unit 78.

### <Second Configuration Example of Hardware of Robot>

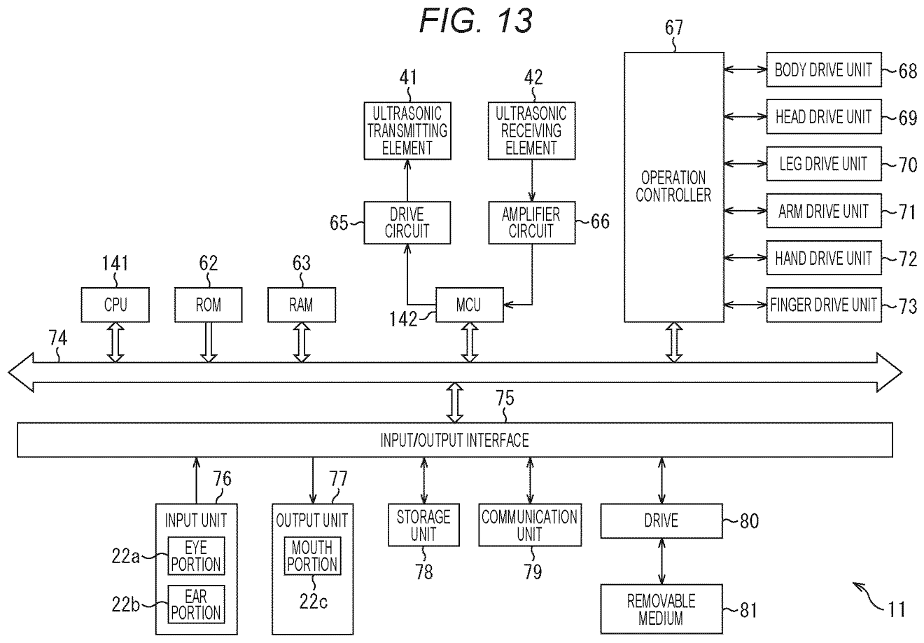

FIG. 13 is a block diagram illustrating a second configuration example of hardware of the robot 11 in FIG. 1.

In the robot 11 in FIG. 13, portions corresponding to those of the robot 11 in FIG. 3 are denoted by the same reference signs. Therefore, description of the portions will be appropriately omitted, and description will be given focusing on portions different from those of the robot 11 in FIG. 3. The robot 11 in FIG. 13 is different from the robot 11 in FIG. 3 in that a CPU 141 and an MCU 142 are provided instead of the CPU 61 and the MCU 64, and is configured similarly to the robot 11 in FIG. 3 in the other respects.

The CPU 141 is a control device that controls the entire robot 11, controls each portion, and performs various processes.

For example, the CPU 141 performs an arrangement process. This arrangement process is similar to the arrangement process performed by the CPU 61 in FIG. 3 except for a speed at which the finger portions 26a and 26b move from initial positions to an arrangement surface. In the arrangement process performed by the CPU 141, the speed at which the finger portions 26a and 26b move from the initial positions to the arrangement surface is set to be slower as the finger portions 26a and 26b approach the arrangement surface on the basis of received wave information supplied from the MCU 142 as a result of ultrasonic sensing at the time of detecting contact of a target object.

The MCU 142 is connected to the drive circuit 65 and the amplifier circuit 66, and performs ultrasonic sensing in response to an instruction from the CPU 141. This ultrasonic sensing is similar to the ultrasonic sensing performed by the MCU 64 of FIG. 3 except for a point that an ultrasonic waveform at the time of estimating the protrusion distance d is held and a method of ultrasonic sensing at the time of detecting contact of the target object. Specifically, the MCU 142 holds the ultrasonic waveform obtained in the ultrasonic sensing at the time of estimating the protrusion distance d in a built-in memory. In the ultrasonic sensing at the time of detecting contact of the target object, the MCU 142 subtracts the ultrasonic waveform held in the built-in memory from a currently generated ultrasonic waveform. The MCU 142 performs signal processing on an ultrasonic waveform obtained as a result of the subtraction to calculate a reception time and a maximum voltage, and supplies the reception time and the maximum voltage to the CPU 141 as the received wave information.

### <Second Configuration Example of Arrangement Processing Unit>

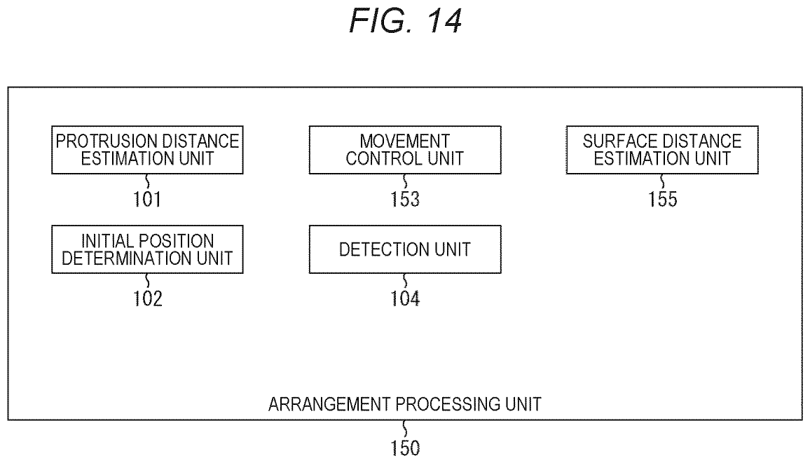

FIG. 14 is a block diagram illustrating a functional configuration example of an arrangement processing unit that performs the arrangement process of the CPU 141 in FIG. 13.

In an arrangement processing unit 150 in FIG. 14, portions corresponding to those of the arrangement processing unit 100 in FIG. 4 are denoted by the same reference signs. Therefore, description of the portions will be appropriately omitted, and description will be given focusing on portions different from those of the arrangement processing unit 100. The arrangement processing unit 150 is different from the arrangement processing unit 100 in that the movement control unit 103 is replaced with a movement control unit 153 and that a surface distance estimation unit 155 is newly provided, and is configured similarly to the arrangement processing unit 100 in the other respects.

Similarly to the movement control unit 103 in FIG. 4, the movement control unit 153 determines an objective gripping position, and instructs the operation controller 67 to move the finger portions 26a and 26b to positions of the finger portions 26a and 26b where the objective gripping position can be gripped by the finger portions 26a and 26b.

Then, the movement control unit 153 instructs the operation controller 67 to cause the finger portions 26a and 26b to grip a target object. As a result, the movement control unit 153 acquires an interval between the finger portions 26a and 26b when the target object is gripped from the operation controller 67, and supplies the interval to the protrusion distance estimation unit 101. The movement control unit 153 instructs the operation controller 67 to lift the target object gripped by the finger portions 26a and 26b.

The movement control unit 153 instructs the operation controller 67 to move the finger portions 26a and 26b to initial positions supplied from the initial position determination unit 102. Then, the movement control unit 153 notifies the detection unit 104 of the completion of the movement. Thereafter, the movement control unit 153 instructs the operation controller 67 to move the finger portions 26a and 26b toward an arrangement surface at a moving speed supplied from the surface distance estimation unit 155. The movement control unit 153 instructs the operation controller 67 to stop the movement of the finger portions 26a and 26b and to release the target object from the finger portions 26a and 26b according to a detection result from the detection unit 104.

The surface distance estimation unit 155 acquires a reception time supplied from the MCU 142 in response to an instruction of the detection unit 104 when the finger portions 26a and 26b are moving toward the arrangement surface. The surface distance estimation unit 155 estimates a surface distance dₚ, which is a distance between the arrangement surface and each of the finger portions 26a and 26b, according to the principle of ToF on the basis of the reception time. The surface distance estimation unit 155 determines the moving speed of the finger portions 26a and 26b on the basis of the surface distance dₚ so as to be slower as the surface distance dₚ is smaller. The surface distance estimation unit 155 supplies the moving speed to the movement control unit 153.

### <Description of Outline of Second Example of Arrangement Process>

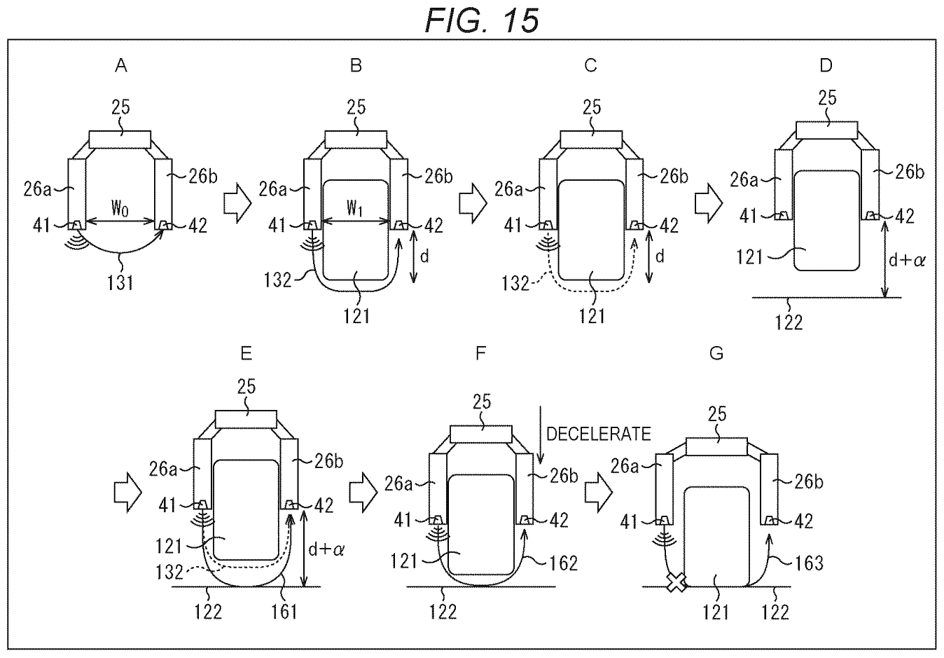

FIG. 15 is a view illustrating an outline of an arrangement process performed by the arrangement processing unit 150 in FIG. 14.

In FIG. 15, portions corresponding to those in FIG. 5 are denoted by the same reference signs. Therefore, description of the portions will be appropriately omitted, and description will be given focusing on portions different from those in FIG. 5.

First, a table in which the reception times t₀ and the widths W₀ are associated with each other is stored in the RAM 63 before the arrangement process as illustrated in A of FIG. 15, similarly to A of FIG. 5. Next, the finger portions 26a and 26b grip an objective gripping position of the target object 121, and the protrusion distance d is estimated by ultrasonic sensing as illustrated in B of FIG. 15, similarly to B of FIG. 5.

Then, as illustrated in C of FIG. 15, the MCU 142 holds an ultrasonic waveform of an ultrasonic wave received by the ultrasonic receiving element 42 through the path 132 obtained as a result of the ultrasonic sensing in B of FIG. 5. Next, the finger portions 26a and 26b move to the initial position as illustrated in D of FIG. 15, similarly to C of FIG. 5.

Thereafter, as illustrated in E of FIG. 15, the MCU 142 performs ultrasonic sensing in accordance with an instruction from the detection unit 104. In this ultrasonic sensing, an ultrasonic wave received by the ultrasonic receiving element 42 is obtained by synthesizing an ultrasonic wave received through the path 132 detouring around the target object 121 and an ultrasonic wave received through a path 161 that is reflected by the arrangement surface 122 and directed to the ultrasonic receiving element 42. Therefore, the MCU 142 subtracts the ultrasonic waveform received through the path 132 held in C of FIG. 15 from the ultrasonic waveform received by the ultrasonic receiving element 42, thereby extracting only the ultrasonic waveform received through the path 161.

The surface distance estimation unit 155 calculates a moving speed v_{ref} on the basis of a reception time of the ultrasonic waveform received through the path 161. In the calculation of the moving speed v_{ref}, first, the surface distance estimation unit 155 estimates the surface distance dₚ according to the principle of ToF. Then, the surface distance estimation unit 155 calculates the moving speeds v_{ref} of the finger portion 26a and the finger portion 26b by the following Formula (4) using the surface distance dₚ and the protrusion distance d.

$${v}_{r e f} = G ( d - {d}_{p} ) \qquad ( 4 )$$

In Formula (4), G is a speed gain, and the upward direction in FIG. 15, that is, a direction away from the arrangement surface 122 is the positive direction. According to Formula (4), the moving speed v_{ref} decelerates until the surface distance dₚ becomes the protrusion distance d.

The movement control unit 153 instructs the operation controller 67 to move the finger portions 26a and 26b toward the arrangement surface 122 at the moving speed v_{ref}. By repeating the ultrasonic sensing, the calculation of the moving speed v_{ref}, and the movement of the finger portions 26a and 26b as described above, the finger portions 26a and 26b move at a lower speed as approaching the arrangement surface 122 as illustrated in F of FIG. 15. At this time, a maximum voltage of an ultrasonic wave, received through a path 163 that is reflected by the arrangement surface 122 and directed to the ultrasonic receiving element 42, increases.

Immediately before the target object 121 comes into contact with the arrangement surface 122, a gap between a surface (a bottom surface in the example of FIG. 15) of the target object 121 on a side closer to the arrangement surface 122 and the arrangement surface 122 decreases as illustrated in G of FIG. 15. Therefore, the maximum voltage of the ultrasonic wave, received by the ultrasonic receiving element 42 through the path 163 that is reflected by the arrangement surface 122 and passes through the gap, decreases. Thus, when the maximum voltage of the ultrasonic wave is smaller than a predetermined threshold, the detection unit 104 detects that the target object 121 has come into contact with the arrangement surface 122.

When the detection unit 104 detects that the target object 121 has come into contact with the arrangement surface 122, the movement control unit 153 stops the movement of the finger portions 26a and 26b, and the target object 121 is released from the finger portions 26a and 26b.

As described above, the moving speed v_{ref} is decelerated as the finger portions 26a and 26b approach the arrangement surface 122 in the arrangement process performed by the arrangement processing unit 150. Therefore, the target object 121 can be arranged on the arrangement surface 122 without applying a strong impact to the target object 121 even in a case where an initial moving speed of the finger portions 26a and 26b is fast.

In the arrangement process performed by the arrangement processing unit 150, the contact of the target object 121 is detected using the maximum voltage of only the ultrasonic wave received through the path 161 that is reflected by the arrangement surface 122 and directed to the ultrasonic receiving element 42. Therefore, detection accuracy of the contact can be improved.

### <Description of Flow of Second Example of Arrangement Process Performed by Arrangement Processing Unit>

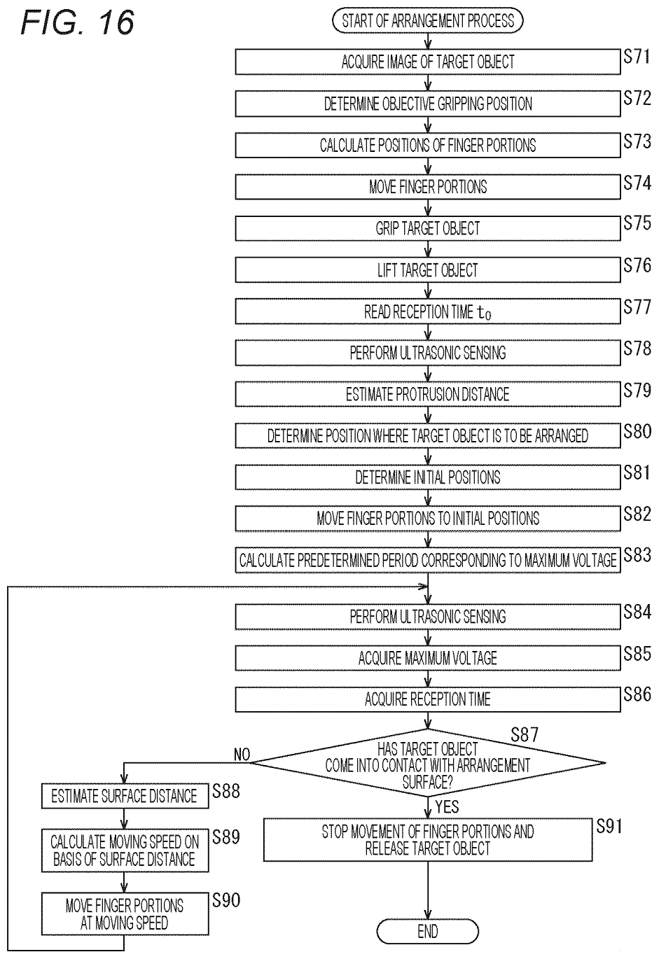

FIG. 16 is a flowchart illustrating the arrangement process performed by the arrangement processing unit 150 in FIG. 14. This arrangement process is started, for example, when the robot 11 places a target object on the tray portion 32 and moves to a transport destination.

Processing from steps S71 to S84 in FIG. 16 is similar to the processing from steps S11 to S24 in FIG. 11, and thus, description thereof will be omitted.

After processing of step S84, in step S85, the detection unit 104 acquires, from the MCU 64, a maximum voltage of only an ultrasonic wave reflected by an arrangement surface and received, which is obtained as a result of ultrasonic sensing. In step S86, the surface distance estimation unit 155 acquires, from the MCU 142, a reception time of only the ultrasonic wave reflected by the arrangement surface and received, which is obtained as a result of ultrasonic sensing.

In step S87, the detection unit 104 determines whether or not the target object has come into contact with the arrangement surface on the basis of the maximum voltage acquired in step S85, similarly to the processing in step S26 in FIG. 11.

In a case where it is determined in step S87 that the target object is not in contact with the arrangement surface, the processing proceeds to step S88. In step S88, the surface distance estimation unit 155 estimates a surface distance according to the principle of ToF on the basis of the reception time acquired in step S86. In step S89, the surface distance estimation unit 155 calculates the moving speed v_{ref} by the above-described Formula (4) on the basis of the surface distance dₚ estimated in step S88. The surface distance estimation unit 155 supplies the moving speed v_{ref} to the movement control unit 153.

In step S90, the movement control unit 153 instructs the operation controller 67 to move the finger portions 26a and 26b toward the arrangement surface for a predetermined time at the moving speed v_{ref}. Then, the processing returns to step S84, and the detection unit 104 instructs the MCU 64 to perform ultrasonic sensing, and the processing proceeds to step S85.

On the other hand, in a case where it is determined in step S87 that the target object has come into contact with the arrangement surface, the detection unit 104 supplies a detection result indicating the contact of the target object with the arrangement surface to the movement control unit 103, and the processing proceeds to step S91. Since processing in step S91 is similar to the processing in step S28 in FIG. 11, description thereof will be omitted. After the processing in step S91, the arrangement process ends.

### Second Embodiment

### <Detailed Configuration Example of Finger Portion>

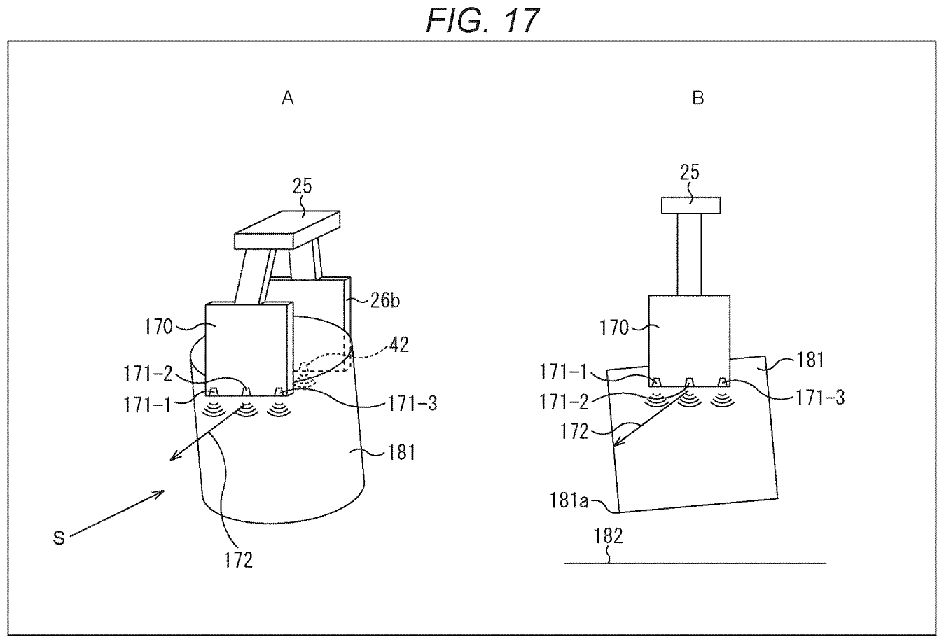

FIG. 17 is a view illustrating a detailed configuration example of a finger portion in a second embodiment of a robot including a control device to which the present technology is applied.

Note that the same ones as those in FIG. 2 are denoted by the same reference signs in FIG. 17.

As illustrated in FIG. 17, in the second embodiment of the robot to which the present technology is applied, a finger portion 170 is connected to the hand portion 25 instead of the finger portion 26a. The finger portion 170 is different from the finger portion 26a in terms of including three ultrasonic transmitting elements 171-1 to 171-3 instead of the single ultrasonic transmitting element 41, and is configured similarly to the finger portion 26a in the other respects.

A of FIG. 17 is a perspective view of a target object 181, the finger portions 170 and 26b, and the hand portion 25 when the target object 181 is gripped by the finger portions 170 and 26b. B of FIG. 17 is a side view of the target object 181, the finger portions 170 and 26b, and the hand portion 25 as viewed from a direction of an arrow S in A of FIG. 17. Note that the ultrasonic transmitting elements 171-1 to 171-3 will be collectively referred to as ultrasonic transmitting elements 171 hereinafter in a case where it is not necessary to distinguish them from one another.

As illustrated in FIG. 17, the three ultrasonic transmitting elements 171 are arranged at a distal end of the finger portion 170 in a direction perpendicular to a direction in which the finger portions 170 and 26b are arrayed.

In a case where the finger portion 170 includes the plurality of ultrasonic transmitting elements 171, a propagation direction of an ultrasonic wave can be changed by adjusting phases of driving voltages of the respective ultrasonic transmitting elements 171. For example, when the ultrasonic transmitting elements 171 are driven in the order of the ultrasonic transmitting elements 171-3, 171-2, and 171-1, the ultrasonic wave propagates in a direction of an arrow 172 as illustrated in FIG. 17. Therefore, the protrusion distance d in the direction of the arrow 172 can be estimated.

Therefore, in the second embodiment, the protrusion distance d of the target object 181 in any direction can be estimated by changing the propagation direction of the ultrasonic wave. As a result, for example, even in a case where the target object 181 is gripped in an inclined manner as illustrated in FIG. 17, a maximum value of the protrusion distance d can be recognized by changing the propagation direction of the ultrasonic wave. Therefore, it is possible to more safely move the finger portion 170 and the finger portion 26b to initial positions without applying an impact to the target object 181 by determining the initial positions on the basis of the maximum value of the protrusion distance d.

Furthermore, in the second embodiment, it is possible to detect contact of a position of the target object 181 in any direction with an arrangement surface 182 by changing the propagation direction of the ultrasonic wave. Therefore, for example, even in the case where the target object 181 is gripped in an inclined manner as illustrated in FIG. 17, it is possible to detect contact with the arrangement surface 182 in the vicinity of a vertex 181a of the target object 181 on the basis of the ultrasonic wave propagated in the direction of the arrow 172. As a result, the target object 181 can be more safely arranged on the arrangement surface 182. Not only in the case where the target object 181 is gripped in an inclined manner but also in a case where the arrangement surface 182 is not a flat surface, it is possible to detect contact with the arrangement surface 182 in the vicinity of a position on the arrangement surface 182 closest to the target object 181 in a direction perpendicular to the arrangement surface 182 on the basis of the ultrasonic wave propagated in a direction toward the position. Therefore, the target object 181 can be more safely and suitably arranged on the arrangement surface 182.

### <Configuration Example of Hardware of Robot>

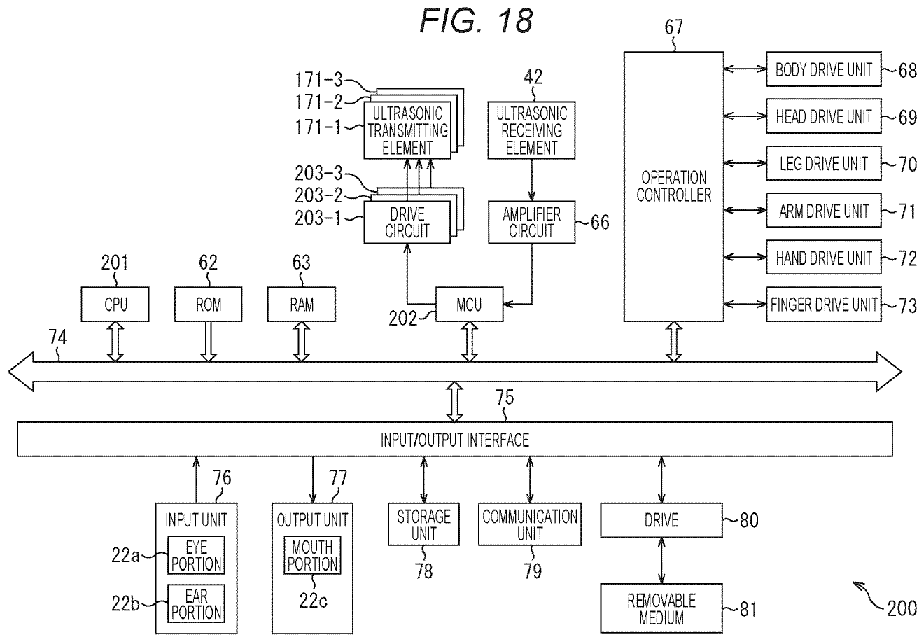

FIG. 18 is a block diagram illustrating a configuration example of hardware in the second embodiment of the robot including the control device to which the present technology is applied.

Note that, in a robot 200 in FIG. 18, portions corresponding to those of the robot 11 in FIG. 3 are denoted by the same reference signs. Therefore, description of the portions will be appropriately omitted, and description will be given focusing on portions different from those of the robot 11. The robot 200 in FIG. 18 is different from the robot 11 in that the CPU 61, the MCU 64, and the drive circuit 65 are replaced with a CPU 201, an MCU 202, and drive circuits 203-1 to 203-3, respectively, and that the ultrasonic transmitting element 41 is replaced with the ultrasonic transmitting elements 171-1 to 171-3, and is configured similarly to the robot 11 in the other respects.

The CPU 201 is a control device that controls the entire robot 11, controls each portion, and performs various processes.

For example, the CPU 201 performs an arrangement process. This arrangement process is similar to the arrangement process performed by the CPU 61 in FIG. 3 except that estimation of a protrusion distance and detection of contact of a target object are performed for each of predetermined directions. In the arrangement process performed by the CPU 201, the MCU 202 is instructed to perform ultrasonic sensing in the predetermined directions. Protrusion distances in the predetermined directions are estimated or contact of the target object with an arrangement surface at positions in the predetermined directions are detected on the basis of reception information in the predetermined directions obtained as results.

The MCU 202 is connected to the drive circuits 203-1 to 203-3 and the amplifier circuit 66, and performs ultrasonic sensing in the predetermined directions in response to an instruction from the CPU 201. Specifically, in response to the instruction from the CPU 201, the MCU 202 drives the ultrasonic transmitting elements 171 by supplying rectangular pulses oscillating at resonance frequencies of the ultrasonic transmitting elements 171 to the drive circuits 203-1 to 203-3 in the order corresponding to the directions in which the ultrasonic sensing is performed, respectively. Furthermore, the MCU 202 generates received wave information using an ultrasonic wave amplified by the amplifier circuit 66 and supplies the received wave information to the CPU 201, similarly to the MCU 64.

The drive circuits 203-1 to 203-3 are connected to the ultrasonic transmitting elements 171-1 to 171-3, respectively. Therefore, an ultrasonic wave output timing from each of the ultrasonic transmitting elements 171 is controlled for each of the ultrasonic transmitting elements 171. Note that the drive circuits 203-1 to 203-3 will be collectively referred to as drive circuits 203 hereinafter in a case where it is not necessary to particularly distinguish them.

Each of the drive circuits 203 is configured similarly to the drive circuit 65, and converts a voltage of the rectangular pulse supplied from the MCU 202 into the driving voltage of each of the ultrasonic transmitting elements 171. Each of the drive circuits 203 supplies the rectangular pulse after the voltage conversion to each of the ultrasonic transmitting elements 171 connected to itself. Therefore, the ultrasonic transmitting elements 171-1 to 171-3 generate and output ultrasonic waves in the order corresponding to the directions in which the ultrasonic sensing is performed. As a result, the ultrasonic waves propagate in the directions in which the ultrasonic sensing is performed.

### <Configuration Example of Arrangement Processing Unit>

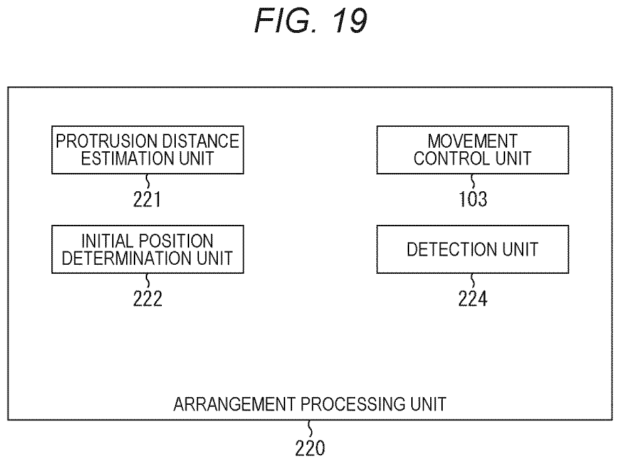

FIG. 19 is a block diagram illustrating a functional configuration example of an arrangement processing unit of the CPU 201 in FIG. 18.

Note that, in an arrangement processing unit 220 in FIG. 19, portions corresponding to those of the arrangement processing unit 100 in FIG. 4 are denoted by the same reference signs. Therefore, description of the portions will be appropriately omitted, and description will be given focusing on portions different from those of the arrangement processing unit 100. The arrangement processing unit 220 in FIG. 19 is different from the arrangement processing unit 100 in that a protrusion distance estimation unit 221, an initial position determination unit 222, and a detection unit 224 are provided instead of the protrusion distance estimation unit 101, the initial position determination unit 102, and the detection unit 104, and is configured similarly to the arrangement processing unit 100 in the other respects.

The protrusion distance estimation unit 221 stores, in the RAM 63, a table in which the reception times t₀ and the widths W₀ are associated with each other, similarly to the protrusion distance estimation unit 101. The protrusion distance estimation unit 221 reads the reception time t₀ from the table stored in the RAM 63, similarly to the protrusion distance estimation unit 101.

Then, the protrusion distance estimation unit 221 instructs the MCU 202 to perform ultrasonic sensing in a predetermined direction, and acquires the reception time t₁ from the MCU 202. The protrusion distance estimation unit 221 estimates the protrusion distance d on the basis of the reception time t₀ and the reception time t₁, similarly to the protrusion distance estimation unit 101. The protrusion distance estimation unit 221 performs the above processing while changing the direction of the ultrasonic sensing, and estimates the protrusion distances d in the respective directions. The protrusion distance estimation unit 221 supplies a maximum protrusion distance dₘₐₓ, which is a maximum value among the estimated protrusion distances d, to the initial position determination unit 222. The protrusion distance estimation unit 221 supplies the maximum protrusion distance dₘₐₓ and a reception time t₁ₘₐₓ, used to estimate the maximum protrusion distance dₘₐₓ, to the detection unit 224.

The initial position determination unit 222 determines a position on the arrangement surface on which the target object is to be arranged, similarly to the initial position determination unit 102. On the basis of the position and the maximum protrusion distance dₘₐₓ, the initial position determination unit 222 determines initial positions of the finger portion 170 and the finger portion 26b at the time of an arrangement operation to be positions higher by (dₘₐₓ+α) than the position on the arrangement surface on which the target object is to be arranged. The initial position determination unit 222 supplies the initial positions to the movement control unit 103.

The detection unit 224 calculates a predetermined period at a maximum voltage on the basis of the maximum protrusion distance dₘₐₓ and the reception time t₁ₘₐₓ supplied from the protrusion distance estimation unit 221, similarly to the detection unit 104.

In response to a notification from the movement control unit 103, the detection unit 224 starts an instruction of ultrasonic sensing in a predetermined direction to the MCU 202 and provides notification of the predetermined period at the maximum voltage, and as a result, acquires the maximum voltage from the MCU 202. The detection unit 224 determines whether or not a position of the target object corresponding to the direction of the ultrasonic sensing has come into contact with the arrangement surface on the basis of the maximum voltage. The detection unit 224 performs the above processing while changing the direction of the ultrasonic sensing, and determines whether or not positions of the target object in the respective directions have come into contact with the arrangement surface.

In a case where it is determined that a position of the target object in any direction has come into contact with the arrangement surface, the detection unit 224 detects the contact of the position with the arrangement surface. The detection unit 224 supplies such a detection result to the movement control unit 103, and ends the instruction of ultrasonic sensing with respect to the MCU 202.

As described above, the robot 200 includes the three ultrasonic transmitting elements 171, and thus, can perform the ultrasonic sensing in the predetermined directions by individually controlling the ultrasonic wave output timings of the respective ultrasonic transmitting elements 171. As a result, the robot 200 can estimate the protrusion distances in the predetermined directions and detect contact of the positions in the predetermined directions of the target object with the arrangement surface. Therefore, even in a case where the target object is gripped in an inclined manner or in a case where the arrangement surface is not a flat surface, the target object can be safely and suitably arranged on the arrangement surface without applying an impact to the target object.

Note that the robot 200 may interpolate an occlusion region of an image of the target object acquired by the eye portion 22a on the basis of the protrusion distances d in the respective directions.

Although the three ultrasonic transmitting elements 171 are provided in the robot 200, the number of ultrasonic transmitting elements is not limited as long as the number is plural.

### Third Embodiment

### <Detailed Configuration Example of Finger Portion>

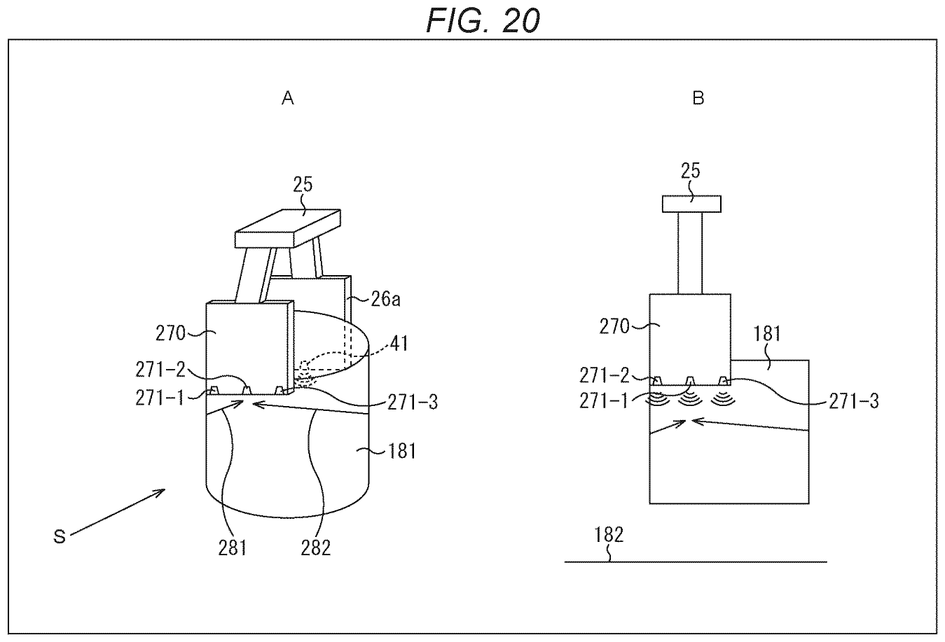

FIG. 20 is a view illustrating a detailed configuration example of a finger portion in a third embodiment of a robot including a control device to which the present technology is applied.

Note that the same ones as those in FIG. 17 are denoted by the same reference signs in FIG. 20.

As illustrated in FIG. 20, in the third embodiment of the robot to which the present technology is applied, a finger portion 270 is connected to the hand portion 25 instead of the finger portion 26b. The finger portion 270 is different from the finger portion 26b in terms of including three ultrasonic receiving elements 271-1 to 271-3 instead of the single ultrasonic receiving element 42, and is configured similarly to the finger portion 26b in the other respects.

A of FIG. 20 is a perspective view of the target object 181, the finger portions 26a and 270, and the hand portion 25 when the target object 181 is gripped by the finger portions 26a and 270. B of FIG. 20 is a side view of the target object 181, the finger portions 26a and 270, and the hand portion 25 as viewed from a direction of an arrow S in A of FIG. 20. Note that the ultrasonic receiving elements 271-1 to 271-3 will be collectively referred to as ultrasonic receiving elements 271 hereinafter in a case where it is not necessary to distinguish them from one another.

As illustrated in FIG. 20, the three ultrasonic receiving elements 271 are arranged at a distal end of the finger portion 270 in a direction perpendicular to a direction in which the finger portions 26a and 270 are arrayed.

In a case where the directivity of the ultrasonic transmitting element 41 is wide, an ultrasonic wave propagates in a wide range, and the ultrasonic wave makes a detour in various directions around the target object 181. In such a case, when the finger portion 270 includes the plurality of ultrasonic receiving elements 271, a deviation occurs in a reception timing of the ultrasonic wave in each of the ultrasonic receiving elements 271 depending on a direction in which the ultrasonic wave arrives, and thus, the arrival direction of the ultrasonic wave can be recognized according to the principle of direction of arrival (DOA) on the basis of such a deviation.

For example, in a case where not the center but the left side of the target object 181 is gripped by the finger portion 26a and the finger portion 270 as illustrated in FIG. 20, first, an ultrasonic wave makes a detour around the target object 181 counterclockwise in the drawing and arrives at the ultrasonic receiving elements 271 from a direction indicated by an arrow 281. Since the ultrasonic wave arrives in the order of the ultrasonic receiving elements 271-1, 271-2, and 271-3, it is possible to recognize that an arrival direction of the ultrasonic wave corresponding to the first peak is the direction indicated by the arrow 281 on the basis of the deviations in reception times of the respective ultrasonic receiving elements 271 according to the principle of DOA. Furthermore, it can be seen that a distance in the direction indicated by the arrow 281 is the shortest, and thus, it can be seen that a gripping position is shifted to the left side from the center. A distance of a path of the arriving ultrasonic wave can be known from the reception time in the ultrasonic receiving element 271-1.

After the ultrasonic wave from the direction indicated by the arrow 281, an ultrasonic wave makes a detour around the target object 181 clockwise in the drawing and arrives at the ultrasonic receiving elements 271 from a direction indicated by an arrow 282. Since the ultrasonic waves arrive in the order of the ultrasonic receiving elements 271-3, 271-2, and 271-1, it is possible to recognize that an arrival direction of the ultrasonic wave is the direction indicated by the arrow 282 on the basis of deviations in peak times of the respective ultrasonic receiving elements 271 according to the principle of DOA. A distance of a path of the arriving ultrasonic wave can be known from the time of the ultrasonic wave received by the ultrasonic receiving element 271-3.

A direction in which an ultrasonic wave has arrived and a distance of a path can be calculated similarly for the ultrasonic wave from a direction other than the directions of the arrows 281 and 282. Therefore, in the third embodiment, it is possible to estimate a three-dimensional protrusion size which is a three-dimensional size of a portion protruding from a gripping position of the target object 181 to an arrangement surface side. As a result, initial positions can be determined more suitably on the basis of the three-dimensional protrusion size. Therefore, it is possible to more safely move the finger portion 26a and the finger portion 270 to the initial positions without applying an impact to the target object 181.

Furthermore, in the third embodiment, at the time of detecting the contact of the target object 181, it is possible to recognize a position in any direction of the target object 181 that has come into contact with the arrangement surface on the basis of the deviations of the reception timings in the respective ultrasonic receiving elements 271 when a voltage of the peak of the ultrasonic waveform becomes lower than a threshold. Therefore, it is possible to detect contact of a position in a predetermined direction of the target object 181 with the arrangement surface 182. Therefore, the target object 181 can be more safely and suitably arranged on the arrangement surface 182, for example, by releasing the target object 181 when a position in a desired direction of the target object 181 has come into contact with the arrangement surface 182.

### <Configuration Example of Hardware of Robot>

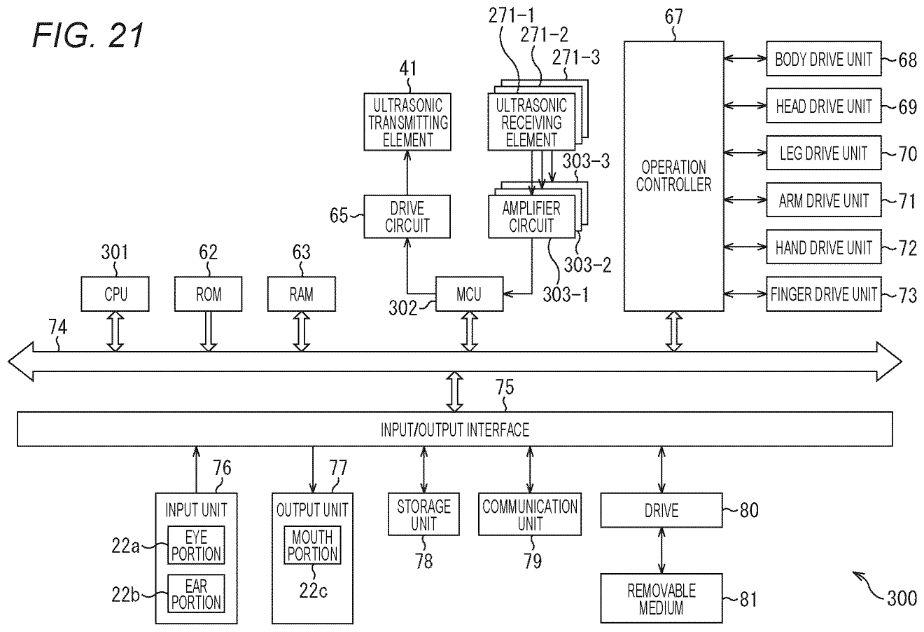

FIG. 21 is a block diagram illustrating a configuration example of hardware in the third embodiment of the robot including the control device to which the present technology is applied.

Note that, in a robot 300 in FIG. 21, portions corresponding to those of the robot 11 in FIG. 3 are denoted by the same reference signs. Therefore, description of the portions will be appropriately omitted, and description will be given focusing on portions different from those of the robot 11. The robot 300 in FIG. 21 is different from the robot 11 in that the CPU 61, the MCU 64, and the amplifier circuit 66 are replaced with a CPU 301, an MCU 302, and amplifier circuits 303-1 to 303-3, respectively, and that the ultrasonic receiving element 42 is replaced with the ultrasonic receiving elements 271-1 to 271-3, and is configured similarly to the robot 11 in the other respects.

The CPU 301 is a control device that controls the entire robot 11, controls each portion, and performs various processes.

For example, the CPU 301 performs an arrangement process. This arrangement process is similar to the arrangement process performed by the CPU 61 in FIG. 3 except that a three-dimensional protrusion size is estimated instead of a protrusion distance and that contact of a position in a predetermined direction of a target object with an arrangement surface is detected. In the arrangement process performed by the CPU 301, peak times, which are times after output of the ultrasonic transmitting element 41, and peak voltages, which are voltages, of peaks of ultrasonic waveforms of ultrasonic waves received by the respective ultrasonic receiving elements 271 are acquired as received wave information by instructing the MCU 302 to perform ultrasonic sensing. On the basis of the received wave information, the three-dimensional protrusion size is estimated, or the contact of the position in the predetermined direction of the target object with the arrangement surface is detected.

The MCU 302 is connected to the drive circuit 65 and the amplifier circuits 303-1 to 303-3, and performs ultrasonic sensing in response to an instruction from the CPU 301. Specifically, the MCU 302 drives the ultrasonic transmitting element 41 in response to an instruction from the CPU 301, similarly to the MCU 64. Furthermore, the MCU 302 includes three built-in AD converters. The MCU 302 samples voltages corresponding to sound pressures of ultrasonic waves amplified by the amplifier circuits 303-1 to 303-3 in the AD converters, respectively. The MCU 302 performs signal processing on digital signals obtained as results of the sampling, thereby calculating the peak times and the peak voltages of the ultrasonic waves amplified by the respective amplifier circuits 303-1 to 303-3. The MCU 302 supplies the peak times, the peak voltages, and the like to the CPU 301 as the received wave information.

The amplifier circuits 303-1 to 303-3 are connected to the ultrasonic receiving elements 271-1 to 271-3, respectively. Note that the amplifier circuits 303-1 to 303-3 will be collectively referred to as the amplifier circuits 303 hereinafter in a case where it is not necessary to particularly distinguish them. Each of the amplifier circuits 303 is configured similarly to the amplifier circuit 66, and amplifies the ultrasonic wave received by each of the ultrasonic receiving elements 271 connected to itself.

### <Configuration Example of Arrangement Processing Unit>

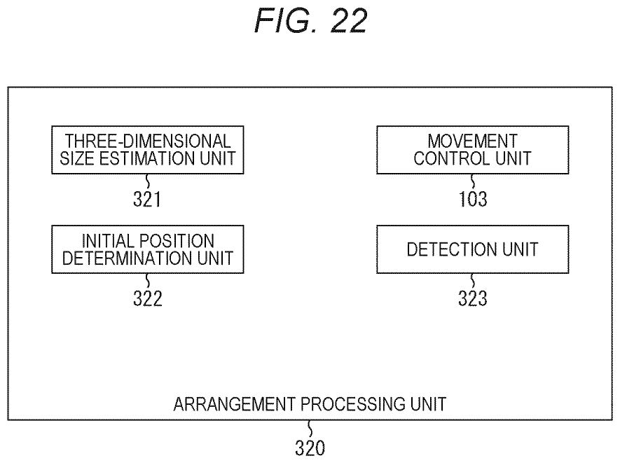

FIG. 22 is a block diagram illustrating a functional configuration example of an arrangement processing unit of the CPU 301 in FIG. 21.

Note that, in an arrangement processing unit 320 in FIG. 22, portions corresponding to those of the arrangement processing unit 100 in FIG. 4 are denoted by the same reference signs. Therefore, description of the portions will be appropriately omitted, and description will be given focusing on portions different from those of the arrangement processing unit 100. The arrangement processing unit 320 in FIG. 22 is different from the arrangement processing unit 100 in that a three-dimensional size estimation unit 321, an initial position determination unit 322, and a detection unit 323 are provided instead of the protrusion distance estimation unit 101, the initial position determination unit 102, and the detection unit 104, and is configured similarly to the arrangement processing unit 100 in the other respects.

The three-dimensional size estimation unit 321 instructs the MCU 302 to perform ultrasonic sensing, and acquires peak times of ultrasonic waves received by the respective ultrasonic receiving element 271 from the MCU 302. The three-dimensional size estimation unit 321 estimates a three-dimensional protrusion size on the basis of the peak times. The three-dimensional size estimation unit 321 supplies the maximum protrusion distance dₘₐₓ of the three-dimensional protrusion size to the initial position determination unit 322.

The initial position determination unit 322 determines a position on the arrangement surface on which the target object is to be arranged, similarly to the initial position determination unit 102. On the basis of the position and the maximum protrusion distance dₘₐₓ, the initial position determination unit 322 determines initial positions of the finger portion 26a and the finger portion 270 at the time of an arrangement operation to be positions higher by (dₘₐₓ+α) than the position on the arrangement surface on which the target object is to be arranged. The initial position determination unit 322 supplies the initial positions to the movement control unit 103.

The detection unit 323 starts an instruction of ultrasonic sensing with respect to the MCU 302 in response to a notification from the movement control unit 103, and as a result, acquires the peak times and peak voltages in the respective ultrasonic receiving elements 271 from the MCU 302. On the basis of the peak times and the peak voltages, the detection unit 323 detects that a position of the target object in a predetermined direction has come into contact with the arrangement surface. The detection unit 323 supplies such a detection result to the movement control unit 103, and ends the instruction of ultrasonic sensing with respect to the MCU 302.

As described above, the robot 300 includes the three ultrasonic receiving elements 271, and thus, can recognize an arrival direction of an ultrasonic wave on the basis of deviations in ultrasonic wave reception timings of the ultrasonic receiving elements 271. As a result, the robot 300 can estimate the three-dimensional protrusion size and detect contact of a position in a predetermined direction of the target object with the arrangement surface. Therefore, even in a case where a gripping position of the target object is shifted from the center, the target object can be arranged at a desired position on the arrangement surface. Furthermore, it is possible to lower the possibility of applying an impact to the target object and to more safely and suitably arrange the target object on the arrangement surface as compared with the robot 11.

Although the three ultrasonic receiving elements 271 are provided in the robot 300, the number of ultrasonic transmitting elements is not limited as long as the number is plural.

Note that not the maximum protrusion distance dₘₐₓ but a protrusion distance in a predetermined direction can be used as the protrusion distance used to calculate the initial positions in the second and third embodiments.

A tactile sensor may be provided on the finger portion 26a (170) or the finger portion 26b (270), or a force sensor may be provided at a position (root) where the hand portion 25 is connected with the arm portion 24. In this case, the detection unit 104 (224, 323) detects that a target object has come into contact with an arrangement surface by also using information regarding a reaction force received by the target object measured by the tactile sensor or the force sensor. Therefore, detection accuracy can be improved as compared with a case where detection is performed by using only an ultrasonic waveform.

The robot 200 (300) may have finger portions other than the finger portion 170 (26a) and the finger portion 26b (270), that is, a plurality of finger portions that does not grip a target object, and each of the finger portions may be provided with an ultrasonic transmitting element (ultrasonic receiving element). In this case, similar processing as in the second embodiment (third embodiment) can be performed by moving finger portions provided with ultrasonic transmitting elements (ultrasonic receiving elements) to array the ultrasonic transmitting elements (ultrasonic receiving elements).

In a case where a three-dimensional size of a target object is known, an objective value of the protrusion distance d is known due to high positional accuracy of movement of the finger portion 26a (170) and the finger portion 26b (270), and an objective value and an estimation value of the protrusion distance d are greatly different from each other, the robot 11 (200, 300) may determine that gripping of an objective gripping position has failed. In this case, the robot 11 (200, 300) may perform a gripping operation again or perform calibration such that an error between an actual gripping position and the objective gripping position becomes zero.

A feature amount such as the number of peaks, a width of a peak, or a peak time of an ultrasonic waveform at the time of gripping a target object varies depending on a shape of the target object and the protrusion distance d (three-dimensional protrusion size). Therefore, the robot 11 (200, 300) may learn the relationship between shapes and the protrusion distances d (three-dimensional protrusion sizes) of objects assumed as the target object, and feature amounts of ultrasonic waveforms at the time of gripping the objects by using a deep neural network (DNN) or the like before the arrangement process. In this case, the robot 11 (200, 300) estimates the shape of the target object and the protrusion distance d (three-dimensional protrusion size) from the feature amount of the ultrasonic waveform at the time of gripping the target object. At this time, the robot 11 (200, 300) may measure information such as the shape and a three-dimensional size of the target object using a three-dimensional sensor, and estimate the shape and the protrusion distance d (three-dimensional protrusion size) of the target object using the information to improve the estimation accuracy.

A feature amount such as a maximum voltage or a peak voltage of an ultrasonic waveform at the time of contact of a target object with an arrangement surface varies depending on a shape and an area of the arrangement surface. Therefore, the robot 11 (200, 300) may learn the relationship between shapes and areas of surfaces assumed as the arrangement surface and feature amounts of ultrasonic waveforms at the time of contact of target objects with the surfaces by using a DNN or the like before the arrangement process. In this case, the robot 11 (200, 300) detects the contact of the target object with the arrangement surface from the feature amount of the ultrasonic waveform. Therefore, accurate contact detection can be performed regardless of shapes and areas of arrangement surfaces.

In a case where the protrusion distance d is long and a received ultrasonic wave is weak, the robot 11 (200, 300) may change a gripping position such that the protrusion distance d is shortened, or may increase a voltage of an ultrasonic waveform by adjusting an amplification factor of the amplifier circuit 66 (303) using a programmable gain amplifier (PGA). The robot 11 (200, 300) can also increase the voltage of the ultrasonic waveform by switching a rectangular pulse voltage to be supplied to the ultrasonic transmitting element 41 (171) or adjusting the number of rectangular pulses with an analog switch or the like.

The eye portion 22a may be a 3D sensor or the like. In this case, the eye portion 22a supplies information acquired by the 3D sensor to the CPU 61 (141, 201, 301).

The program executed by the CPU 61 (141, 201, 301) may be a program in which the processes are performed in time series in the order described in the present description, or may be a program in which the processes are performed in parallel or at a necessary timing such as when a call is made.

A series of processes in the robot 11 (200, 300) is executed by software in the above description, but can also be executed by hardware.

Embodiments of the present technology are not limited to the above-described embodiments, and various modifications can be made within a scope not departing from the gist of the present technology.

For example, it is possible to adopt a mode obtained by combining all or some of the plurality of embodiments described above. In the second embodiment and the third embodiment, the surface distance dₚ can be estimated, and a moving speed of each of the finger portion 170 (26a) and the finger portion 26b (270) toward an arrangement surface can be set to the moving speed v_{ref}.

The present technology may be configured as cloud computing in which one function is shared by a plurality of devices through a network to process together.

Each of the steps in the flowcharts described above can be executed by one device or shared and executed by a plurality of devices.

In a case where one step includes a plurality of processes, the plurality of processes included in the one step can be executed by one device, and also shared and executed by a plurality of devices.

The effects described in the present specification are merely examples and are not limited, and effects other than those described in the present specification may be provided.

Note that, the present technology can have the following configurations.
(1)
A control device including
a detection unit that detects contact of an object with a predetermined surface, in a case where the object, gripped by a first finger portion including an ultrasonic transmitter that generates an ultrasonic wave and a second finger portion including an ultrasonic receiver that receives the ultrasonic wave output from the ultrasonic transmitter, is to be arranged on the predetermined surface, on the basis of a sound pressure of the ultrasonic wave received by the ultrasonic receiver.
(2)
The control device according to (1), in which
the detection unit detects that the object has come into contact with the predetermined surface when a maximum value of a voltage corresponding to the sound pressure of the ultrasonic wave received by the ultrasonic receiver is smaller than a threshold.
(3)
The control device according to (2), in which
the detection unit detects that the object has come into contact with the predetermined surface when the maximum value in a predetermined period is smaller than the threshold.
(4)
The control device according to (3), in which
the predetermined period is determined on the basis of a sound pressure of the ultrasonic wave when the first finger portion and the second finger portion grip the object.
(5)
The control device according to any one of (1) to (4), further including:
a protrusion distance estimation unit that estimates a protrusion distance, which is a distance of the object protruding from a gripping position to a side of the predetermined surface, on the basis of the sound pressure of the ultrasonic wave received by the ultrasonic receiver;
an initial position determination unit that determines initial positions of the first finger portion and the second finger portion on the basis of the protrusion distance estimated by the protrusion distance estimation unit; and
a movement control unit that moves the first finger portion and the second finger portion from the initial positions determined by the initial position determination unit toward the predetermined surface in the case where the object is to be arranged on the predetermined surface.
(6)
The control device according to (5), further including
a surface distance estimation unit that estimates a surface distance, which is a distance between the predetermined surface and each of the first finger portion and the second finger portion on the basis of a waveform obtained by subtracting a waveform of the ultrasonic wave used to estimate the protrusion distance by the protrusion distance estimation unit from a waveform of the ultrasonic wave received by the ultrasonic receiver during the movement of the first finger portion and the second finger portion,
in which the movement control unit moves the first finger portion and the second finger portion toward the predetermined surface at a speed based on the surface distance estimated by the surface distance estimation unit.
(7)
The control device according to (5) or (6), in which
the protrusion distance estimation unit estimates the protrusion distance on the basis of a peak time of a voltage corresponding to the sound pressure of the ultrasonic wave.
(8)
The control device according to any one of (5) to (7), in which
the movement control unit stops the movement of the first finger portion and the second finger portion in a case where the detection unit detects the contact of the object with the predetermined surface.
(9)
The control device according to any one of (1) to (4), in which
the first finger portion includes a plurality of the ultrasonic transmitters,
an output timing of the ultrasonic wave is controlled for each of the ultrasonic transmitters in the plurality of ultrasonic transmitters, and
the detection unit detects contact of a predetermined position of the object with the predetermined surface on the basis of a sound pressure of the ultrasonic wave output from each of the plurality of ultrasonic transmitters and received by the ultrasonic receiver.
(10)
The control device according to (9), further including:
a protrusion distance estimation unit that estimates a protrusion distance, which is a distance in a predetermined direction of a portion of the object protruding from a gripping position to a side of the predetermined surface, on the basis of the sound pressure of the ultrasonic wave output from each of the plurality of ultrasonic transmitters and received by the ultrasonic receiver;
an initial position determination unit that determines initial positions of the first finger portion and the second finger portion on the basis of the protrusion distance estimated by the protrusion distance estimation unit; and
a movement control unit that moves the first finger portion and the second finger portion from the initial positions determined by the initial position determination unit toward the predetermined surface in the case where the object is to be arranged on the predetermined surface.
(11)
The control device according to (1), in which
the second finger portion includes a plurality of the ultrasonic receivers, and
the detection unit detects contact of a predetermined position of the object with the predetermined surface on the basis of a sound pressure of the ultrasonic wave received by each of the plurality of ultrasonic receivers.
(12)
The control device according to (11), further including:
a three-dimensional size estimation unit that estimates a three-dimensional size of a portion of the object protruding from a gripping position to a side of the predetermined surface on the basis of the sound pressure of the ultrasonic wave received by each of the plurality of ultrasonic receivers;
an initial position determination unit that determines initial positions of the first finger portion and the second finger portion on the basis of the three-dimensional size estimated by the three-dimensional size estimation unit; and
a movement control unit that moves the first finger portion and the second finger portion from the initial positions determined by the initial position determination unit toward the predetermined surface in the case where the object is to be arranged on the predetermined surface.
(13)
A control method including
detecting, by a control device, contact of an object with a predetermined surface, in a case where the object, gripped by a first finger portion including an ultrasonic transmitter that generates an ultrasonic wave and a second finger portion including an ultrasonic receiver that receives the ultrasonic wave output from the ultrasonic transmitter is to be arranged on the predetermined surface, is to be arranged on the predetermined surface, on the basis of a sound pressure of the ultrasonic wave received by the ultrasonic receiver.
(14)
A program for causing a computer to function as
a detection unit that detects contact of an object with a predetermined surface, in a case where the object, gripped by a first finger portion including an ultrasonic transmitter that generates an ultrasonic wave and a second finger portion including an ultrasonic receiver that receives the ultrasonic wave output from the ultrasonic transmitter is to be arranged on the predetermined surface, is to be arranged on the predetermined surface, on the basis of a sound pressure of the ultrasonic wave received by the ultrasonic receiver.

### REFERENCE SIGNS LIST

26a, 26b Finger portion
41 Ultrasonic transmitting element
42 Ultrasonic receiving element
61 CPU
101 Protrusion distance estimation unit
102 Initial position determination unit
103 Movement control unit
104 Detection unit
121 Target object
122 Arrangement surface
141 CPU
153 Movement control unit
155 Surface distance estimation unit
170 Finger portion
171-1 to 171-3 Ultrasonic transmitting element
181 Target object
182 Arrangement surface
201 CPU
221 Protrusion distance estimation unit
222 Initial position determination unit
224 Detection unit
270 Finger portion
271-1 to 271-3 Ultrasonic receiving element
301 CPU
321 Three-dimensional size estimation unit
322 Initial position determination unit
323 Detection unit

1. A control device comprising
a detection unit that detects contact of an object with a predetermined surface, in a case where the object, gripped by a first finger portion including an ultrasonic transmitter that generates an ultrasonic wave and a second finger portion including an ultrasonic receiver that receives the ultrasonic wave output from the ultrasonic transmitter, is to be arranged on the predetermined surface, on a basis of a sound pressure of the ultrasonic wave received by the ultrasonic receiver.

2. The control device according to claim 1, wherein
the detection unit detects that the object has come into contact with the predetermined surface when a maximum value of a voltage corresponding to the sound pressure of the ultrasonic wave received by the ultrasonic receiver is smaller than a threshold.

3. The control device according to claim 2, wherein
the detection unit detects that the object has come into contact with the predetermined surface when the maximum value in a predetermined period is smaller than the threshold.

4. The control device according to claim 3, wherein
the predetermined period is determined on a basis of a sound pressure of the ultrasonic wave when the first finger portion and the second finger portion grip the object.

5. The control device according to claim 1, further comprising:
a protrusion distance estimation unit that estimates a protrusion distance, which is a distance of the object protruding from a gripping position to a side of the predetermined surface, on a basis of the sound pressure of the ultrasonic wave received by the ultrasonic receiver;
an initial position determination unit that determines initial positions of the first finger portion and the second finger portion on a basis of the protrusion distance estimated by the protrusion distance estimation unit; and
a movement control unit that moves the first finger portion and the second finger portion from the initial positions determined by the initial position determination unit toward the predetermined surface in the case where the object is to be arranged on the predetermined surface.

6. The control device according to claim 5, further comprising
a surface distance estimation unit that estimates a surface distance, which is a distance between the predetermined surface and each of the first finger portion and the second finger portion on a basis of a waveform obtained by subtracting a waveform of the ultrasonic wave used to estimate the protrusion distance by the protrusion distance estimation unit from a waveform of the ultrasonic wave received by the ultrasonic receiver during the movement of the first finger portion and the second finger portion,
wherein the movement control unit moves the first finger portion and the second finger portion toward the predetermined surface at a speed based on the surface distance estimated by the surface distance estimation unit.

7. The control device according to claim 5, wherein
the protrusion distance estimation unit estimates the protrusion distance on a basis of a peak time of a voltage corresponding to the sound pressure of the ultrasonic wave.

8. The control device according to claim 5, wherein
the movement control unit stops the movement of the first finger portion and the second finger portion in a case where the detection unit detects the contact of the object with the predetermined surface.

9. The control device according to claim 1, wherein
the first finger portion includes a plurality of the ultrasonic transmitters,
an output timing of the ultrasonic wave is controlled for each of the ultrasonic transmitters in the plurality of ultrasonic transmitters, and
the detection unit detects contact of a predetermined position of the object with the predetermined surface on a basis of a sound pressure of the ultrasonic wave output from each of the plurality of ultrasonic transmitters and received by the ultrasonic receiver.

10. The control device according to claim 9, further comprising:
a protrusion distance estimation unit that estimates a protrusion distance, which is a distance in a predetermined direction of a portion of the object protruding from a gripping position to a side of the predetermined surface, on a basis of the sound pressure of the ultrasonic wave output from each of the plurality of ultrasonic transmitters and received by the ultrasonic receiver;
an initial position determination unit that determines initial positions of the first finger portion and the second finger portion on a basis of the protrusion distance estimated by the protrusion distance estimation unit; and
a movement control unit that moves the first finger portion and the second finger portion from the initial positions determined by the initial position determination unit toward the predetermined surface in the case where the object is to be arranged on the predetermined surface.

11. The control device according to claim 1, wherein
the second finger portion includes a plurality of the ultrasonic receivers, and
the detection unit detects contact of a predetermined position of the object with the predetermined surface on a basis of a sound pressure of the ultrasonic wave received by each of the plurality of ultrasonic receivers.

12. The control device according to claim 11, further comprising:
a three-dimensional size estimation unit that estimates a three-dimensional size of a portion of the object protruding from a gripping position to a side of the predetermined surface on a basis of the sound pressure of the ultrasonic wave received by each of the plurality of ultrasonic receivers;
an initial position determination unit that determines initial positions of the first finger portion and the second finger portion on a basis of the three-dimensional size estimated by the three-dimensional size estimation unit; and
a movement control unit that moves the first finger portion and the second finger portion from the initial positions determined by the initial position determination unit toward the predetermined surface in the case where the object is to be arranged on the predetermined surface.

13. A control method comprising
detecting, by a control device, contact of an object with a predetermined surface, in a case where the object, gripped by a first finger portion including an ultrasonic transmitter that generates an ultrasonic wave and a second finger portion including an ultrasonic receiver that receives the ultrasonic wave output from the ultrasonic transmitter, is to be arranged on the predetermined surface, on a basis of a sound pressure of the ultrasonic wave received by the ultrasonic receiver.

14. A program for causing a computer to function as
a detection unit that detects contact of an object with a predetermined surface, in a case where the object, gripped by a first finger portion including an ultrasonic transmitter that generates an ultrasonic wave and a second finger portion including an ultrasonic receiver that receives the ultrasonic wave output from the ultrasonic transmitter, is to be arranged on the predetermined surface, on a basis of a sound pressure of the ultrasonic wave received by the ultrasonic receiver.
